(19) United States
(12) Patent Application Publication
(10) Pub. No.: US 2026/0159107 A1
(43) Pub. Date: Jun. 11, 2026

(54) ACTUATOR SYNCHRONIZATION AND BRAKING SYSTEMS

(71) Applicant: Doftek Pty Ltd, Bayswater (AU)

(72) Inventors: Geoffrey William ROGERS, Upper Gundowring (AU); Ronan FERNANDEZ, Lynbrook (AU); Manuel SANCHEZ PAEZ, Chelsea (AU)

(21) Appl. No.: 19/411,162

(22) Filed: Dec. 5, 2025

Related U.S. Application Data
(60) Provisional application No. 63/728,645, filed on Dec. 5, 2024.

(51) Int. Cl. B60W 50/06; B60W 10/20; B60W 10/22; B60W 50/00; B62D 17/00; H04L 12/40; H04L 67/12

(52) U.S. Cl. CPC B60W 50/06; B60W 10/20; B60W 10/22; B62D 17/00; H04L 12/40; H04L 67/12; B60W 2050/0094; H04L 2012/40273

(57) ABSTRACT

Apparatuses and methods for synchronizing wheel alignment control and/or adjustment systems are described herein and may include control hardware, software and/or firmware for receiving and processing data and outputting control commands for one or more electromechanical apparatuses for controlling vehicle suspension settings. These methods and apparatuses may dynamically and iteratively reassign which of the wheel alignment controls is the master and which is the slave, and may determine a common reference frame for the wheel alignment controls. A braking apparatus may include an engagement pin and a brake disc. The brake disc can include two engagement zones to sequentially engage with the engagement pin and stop rotation of a shaft.

### CLAIM OF PRIORITY

This patent application claims priority to U.S. provisional Ser. No. 63/728,645, titled “SYNCHRONIZATION FOR WHEEL ALIGNMENT SYSTEMS,” filed on Dec. 5, 2024, and herein incorporated by reference in its entirety.

### BACKGROUND

Vehicle alignment systems may set positional settings on a vehicle's (e.g. an automobile's) suspension system, which may significantly affect the vehicle's driving characteristics, including handling, tire wear, fuel efficiency, battery range, emissions, safety, passenger comfort, and the like. Such systems may be difficult to control when included together, as modifying one setting may affect, often in unpredictable ways, vehicle performance as it relates to the other settings. For example, camber, castor and toe adjustments must be dynamic, depending on both vehicle environmental (e.g., driving) conditions as well as the effects of other adjustments. Synchronization must be performed in real time and must respond to a variety of important factors.

Thus, the synchronization of wheel alignment elements, such as camber, castor, and toe, may be a critical factor in optimizing a vehicle's driving characteristics. Precise coordination of these settings significantly influences handling, safety, tire wear, fuel efficiency, battery range, emissions and passenger comfort. For vehicles used in diverse conditions, such as commuting and recreational driving, achieving the right balance between these settings is essential. Synchronizing alignment elements allows the vehicle to seamlessly adapt to varying conditions, ensuring that performance, comfort, and efficiency are maintained without compromising safety. Traditional manual adjustments can be labor-intensive and costly, particularly for users who frequently change driving conditions. Automated or semi-automated systems that enable real-time monitoring and adjustment of wheel alignment elements provide a transformative solution. There is a need for synchronization systems that can deal with highly complex and highly dynamic load cases, ensuring alignment remains within optimal thresholds for any driving scenario.

Some conventional braking systems can be effective under standard operating conditions; however, they may exhibit limitations when subjected to repeated, high-speed application. At elevated velocities, conventional brake designs may suffer from reduced stopping effectiveness compromising vehicle safety and performance.

These shortcomings highlight the need for an improved braking mechanism that offers enhanced performance at high speeds, superior durability, and consistent reliability over extended use.

The apparatuses and methods described herein may address these needs.

### SUMMARY OF THE DISCLOSURE

Described herein are apparatuses (e.g., systems, devices, etc., including software, firmware and hardware) and methods for synchronizing wheel alignment control and/or adjustment systems. These wheel alignment synchronizing apparatuses may include one or more electromechanical apparatuses for controlling vehicle suspension settings and control hardware, software and/or firmware for receiving and processing sensor data and outputting control commands.

Traditional synchronization of motors (e.g., drivers), may typically divide a system into master (e.g., leader) and slave (e.g., follower) components, in which there is one master, and the slave(s) may track the master. However, such systems are not well suited for control of a vehicle in real-time, because such systems respond poorly to external load disturbances. For example if exposed to an unexpectedly large (e.g., unpredictable) load, these systems may cause slowing of the motor seeing the large load, but not the motor seeing the other load. One technique to address this has been to provide more powerful motors that can overpower all possible external loads (i.e. do not need to adapt to large loads), however such a solution is not practical under all conditions, particularly in the automotive space. The apparatuses described herein may instead provide dynamic synchronization that may allow a real-time response to virtually any disturbance while maintaining synchronization very accurately.

The methods and apparatuses described herein may also use a master/slave (e.g., master/slave) configuration but may dynamically assign the master/slave roles during operation of the apparatus. In addition, these methods and apparatuses may coordinate the activity of a variety of different actuators for wheel alignment, including but not limited to multiple actuators (for some or all of the vehicle's tires) for camber, castor and/or toe, and may resolve these various actuators into a single reference frame. Thus, these actuators may not necessarily be individually synchronized to their own axis of travel but instead may be synchronized to a common axis. The apparatuses and methods described herein equally apply to linear and non-linear output actuators.

The use of a dynamic determination of the master and slaves (leader/follower) may be performed in an ongoing manner. Thus, these methods and apparatuses may be configured to compare, in real time, the performance of the various alignment actuators and may identify which of the actuators are lagging the others; in some cases the lagging actuator may become the master, and the other actuators may become the slaves. The use of a common reference frame, as will be described in greater detail below, may allow the actuators to be compared quickly and effectively to determine and track changes while driving, even at high speeds and in a variety of different road conditions. For example, each actuator may have a position set point target, which may be continuously changing while driving; in some cases each actuator may have a target position (e.g., a set point) that may be determined by a synchronization controller. The synchronization controller may dynamically determine the master/slaves and may receive input from each actuator as well as one or more additional sensors. The synchronization controller may determine the common path for the overall system, e.g., the common reference frame. The synchronization controller may be referred to as a high-level controller, a high-level alignment controller and may act as a position setpoint controller.

As mentioned, the synchronization controllers described herein may include software, firmware and hardware. In general any of the apparatuses may include one or more processors, control logic and timing circuitry. The synchronization controller may receive input from one or more actuators and may be configured as part of or coupled to, a vehicle's electronic control unit (ECU). The timing circuitry may control the loop rate for the apparatus, which may be, for example, a minimum of 100 Hz (e.g., 10 ms) (e.g., 300 Hz, 400 Hz, 500 Hz, 1 kHz, etc.). The synchronization controller may be configured to work with a plurality of different alignment actuators, which may be different types. Examples of alignment actuators that may be used include but are not limited to those described in U.S. Pat. No. 10,112,649, titled “ELECTROMECHANICAL DEVICES FOR CONTROLLING VEHICLE SUSPENSION SETTINGS,” U.S. Pat. No. 11,565,752, titled “ELECTROMECHANICAL DEVICES FOR CONTROLLING VEHICLE SUSPENSION SETTINGS,” U.S. Pat. No. 12,084,110, titled “ELECTROMECHANICAL DEVICES FOR CONTROLLING VEHICLE SUSPENSION SETTINGS,” U.S. patent application Ser. No. 18/762,621, titled “ELECTROMECHANICAL DEVICES FOR CONTROLLING VEHICLE SUSPENSION SETTINGS,” and filed on Jul. 2, 2024, and U.S. patent application Ser. No. 18/249,056, titled “WHEEL ALIGNMENT SYSTEMS,” filed on Oct. 13, 2021, each of which is herein incorporated by reference in its entirety. Other actuators that may be included as part of the synchronization apparatuses (or used with these synchronization apparatuses described herein) may include rear wheel steering actuators.

The methods and apparatuses for synchronizing vehicle actuators (e.g., vehicle alignment actuators) described herein may also use velocity correction in addition to converting all of the actuators into a common reference frame and dynamically determining the master/slave(s) between the actuators.

For example, described herein are methods of synchronizing a plurality of alignment actuators, the method comprising: receiving operational data for each of the plurality of wheel alignment actuators; setting a common reference frame for each wheel alignment actuator; dynamically reassigning which of the plurality of wheel alignment actuator is the master and which are slaves; determining an updated target operation for each of the plurality of wheel alignment actuators based on the reassigned master and slaves; and converting the updated target operation for each of the plurality of wheel alignment actuators from the common reference frame to a native reference frame for each actuator so that each actuator may operate on the native reference frame.

The step of receiving operational data for each of the plurality of wheel alignment actuators may comprise receiving operation data for one or more camber wheel alignment actuator, castor wheel alignment actuator, and/or toe wheel alignment actuator. In general, these methods and apparatuses may be operated at 100 Hz or greater (e.g., 200 Hz or greater, 400 Hz or greater, 500 Hz or greater, 700 Hz or greater, 1kHz or greater, etc.). Converting may comprise converting the updated target operation for each of the plurality of wheel alignment at greater than 100 Hz.

The operational data may comprise position input (e.g., actual position) for each actuator and/or target position. The operational data may include position input for each actuator including a target position and an actual position. Dynamically reassigning which of the plurality of wheel alignment actuator is the master and which are slaves may be based on performance of each actuator, to identify which of the actuators is lagging in reaching the target position corresponding to the common path target. Any of these methods may include determining a position error for each actuator based on the received target position and actual position.

Determining an updated target operation for each of the plurality of wheel alignment actuators may comprise determining based on a synchronization error between the operational data and a target position and an actual position of each of the plurality of wheel alignment actuators. Converting may comprise converting the updated target operation for each of the plurality of wheel alignment actuators from the common reference frame to the native reference frame for each actuator by applying a transfer function and/or map specific to each actuator so that each actuator may operate on the native reference frame.

For example, a method of synchronizing a plurality of alignment actuators may include: receiving operational data for each of the plurality of wheel alignment actuators including a target position and an actual position for each of the plurality of wheel alignment actuators; setting a common reference frame for each wheel alignment actuator; dynamically reassigning which of the plurality of wheel alignment actuator is the master and which are slaves based on which of the actuators is lagging the most; determining an updated target operation for each of the plurality of wheel alignment actuators based on the reassigned master and slaves; and converting the updated target operation for each of the plurality of wheel alignment actuators from the common reference frame to a native reference frame for each actuator so that each actuator may operate on the native reference frame.

Also described herein are apparatuses (e.g., systems) for performing any of these methods. For example, a system for synchronizing a plurality of alignment actuators may include: one or more processors; a memory coupled to the one or more processors, the memory storing computer-readable instructions that, when executed by the one or more processors, causes the one or more processors to: receive operational data for each of the plurality of wheel alignment actuators; set a common reference frame for each wheel alignment actuator; dynamically reassign which of the plurality of wheel alignment actuator is the master and which are slaves; determine an updated target operation for each of the plurality of wheel alignment actuators based on the reassigned master and slaves; and convert the updated target operation for each of the plurality of wheel alignment actuators from the common reference frame to a native reference frame for each actuator so that each actuator may operate on the native reference frame. Any of these systems may include the alignment actuators or may be configured to operate with preexisting alignment actuators.

For example, a system for synchronizing a plurality of alignment actuators may include: one or more processors; a memory coupled to the one or more processors, the memory storing computer-readable instructions that, when executed by the one or more processors, causes the one or more processors to: receive operational data for each of the plurality of wheel alignment actuators including a target position and an actual position for each of the plurality of wheel alignment actuators; set a common reference frame for each wheel alignment actuator; dynamically reassign which of the plurality of wheel alignment actuator is the master and which are slaves based on which of the actuators is lagging the most; determine an updated target operation for each of the plurality of wheel alignment actuators based on the reassigned master and slaves; and convert the updated target operation for each of the plurality of wheel alignment actuators from the common reference frame to a native reference frame for each actuator so that each actuator may operate on the native reference frame.

Described herein are methods that can be used to synchronize a plurality of electronic control units (ECUs). The method may include receiving, by a first ECU, a first message from a second ECU, where the first message includes a first timing reference frame for actuators controlled by the second ECU, determining a second timing reference frame for actuators controlled by the first ECU, and determining, based on the first timing reference frame and the second timing reference frame, a global timing reference frame, where the global timing reference frame includes timing information to synchronize the actuators controlled by the first ECU and the actuators controlled by the second ECU.

In any of the methods described herein, the method can further include determining a target position for the actuators controlled by the first ECU and the actuators controlled by the second ECU based on the global timing reference frame.

In any of the methods described herein, the method can further include initiating actuator movement based on the determined target position.

In any of the methods described herein, the method can further include synchronizing some or all of the actuators controlled by the first ECU with some or all of the actuators controlled by the second ECU. It is not necessary to always synchronize all of the actuators controlled by the first ECU with all of the actuators controlled by the second ECU.

In any of the methods described herein, one or more of the actuators can control a steering geometry of a motor vehicle.

In any of the methods described herein, one or more of the actuators can control a suspension geometry of a motor vehicle.

In any of the methods described herein, the timing information to synchronize the actuators controlled by the first ECU and the actuators controlled by the second ECU can be based on the slowest actuator controlled by the first ECU and the second ECU.

In any of the methods described herein, the method can further include transmitting, by the first ECU, a second message to the second ECU determining the global timing reference frame.

In any of the methods described herein, the method can further include waiting, by the first ECU, to receive the first message prior to determining the local timing reference frame.

In any of the methods described herein, the global timing reference frame can be based on the slowest actuator controlled by the first ECU and the second ECU.

In any of the methods described herein, more than two ECUs can be synchronized.

Described herein are methods that can be used to synchronize a plurality of electronic control units (ECUs). The method may include waiting, by a first ECU, for a predetermined time period, followed by determining a local timing reference frame, where the local reference frame includes timing information for actuators controlled by the first ECU. The method may further include transmitting a first message to a second ECU, where the first message includes the local reference frame of the first ECU, and receiving a second message from the second ECU, where the second message includes a global reference frame with timing information to synchronize the actuators controlled by the first ECU and the actuators controlled by the second ECU. Based on the global timing reference frame, the method may include determining a target position for the actuators controlled by the first ECU and the actuators controlled by the second ECU.

In any of the methods described herein, the method can further include waiting to receive the second message after transmitting the first message, where the target position is not determined until after the second message is received.

In any of the methods described herein, the method can further include initiating actuator movement based on the determined target position.

In any of the methods described herein, the method can further include waiting an additional predetermined time period after determining the target position before updating the local timing reference frame.

In any of the methods described herein, one or more of the actuators can control a steering geometry of a motor vehicle.

In any of the methods described herein, one or more of the actuators can control a suspension geometry of a motor vehicle.

Also described herein are additional methods that can be used to synchronize a plurality of electronic control units (ECUs) in a motor vehicle. Any of the methods may include waiting, by a first ECU, to receive a first message from a second ECU, determining a first timing reference frame for actuators controlled by the first ECU where the first reference frame includes timing information for those actuators, receiving a second message from the second ECU where the second message includes a second timing reference frame comprising timing information for actuators of the second ECU, determining a global timing reference frame based on the first and second timing reference frames where the global timing reference frame includes timing information to synchronize the actuators controlled by both the first and second ECUs, and transmitting the global timing reference frame to the second ECU.

In any of the methods described herein, the method can further include determining a target position for the actuators controlled by the first ECU and the actuators controlled by the second ECU based on the global timing reference frame.

In any of the methods described herein, the method can further include initiating actuator movement based on the determined target position.

In any of the methods described herein, the method can include actuators that control a steering geometry of a motor vehicle.

In any of the methods described herein, the method can include actuators that control a suspension geometry of a motor vehicle.

Also described herein are methods that can be used to synchronize a plurality of electronic control units (ECUs). In any of these methods, a first ECU may wait for an internal timer to elapse, then transmit a message to a second ECU to determine a first timing reference frame that includes timing information for actuators controlled by the second ECU. The first ECU may then determine a second timing reference frame that includes timing information for actuators under its own control and transmit this second timing reference frame to the second ECU. Subsequently, the first ECU may receive a global timing reference frame that includes timing information sufficient to synchronize the actuators controlled by both the first and second ECUs.

In any of the methods described herein, the first ECU can determine a target position for its actuators based on the global timing reference frame.

In any of the methods described herein, the second ECU can determine a target position for its actuators based on the global synchronization frame.

In any of the methods described herein, actuator movement can be initiated based on the determined target position.

In some examples, the first ECU can wait for a second predetermined time period after determining the target position before transmitting a second message to the second ECU to determine an updated timing reference frame.

In any of the methods described herein, one or more of the actuators can control a steering geometry of a motor vehicle.

In some examples, one or more of the actuators can control a suspension geometry of a motor vehicle.

Described herein are methods that can be used to synchronize a plurality of electronic control units (ECUs). The method may include determining a first timing reference frame for actuators controlled by a first ECU, where the first timing reference frame includes timing information for the actuators controlled by the first ECU. The method may further include receiving a second timing reference frame from a second ECU, where the second timing reference frame includes timing information for the actuators controlled by the second ECU. A global timing reference signal may then be determined based on the first timing reference frame and the second timing reference frame, where the global timing reference frame includes timing information to synchronize the actuators controlled by the first and second ECUs. Additionally, the method may include determining a target position for the actuators controlled by the first and second ECUs based on the global timing reference frame.

Described herein are methods that can be used to synchronize a plurality of electronic control units (ECUs). The method may include determining a local timing reference frame for actuators controlled by a first ECU, where the local reference frame includes timing information specific to those actuators. The method may further include receiving one or more secondary timing reference frames from one or more additional ECUs, where each secondary reference frame includes timing information for actuators controlled by its respective ECU. A global timing reference frame may then be determined based on the local and secondary timing reference frames, where the global timing reference frame includes timing information sufficient to synchronize the actuators controlled by both the first ECU and the one or more secondary ECUs. The method may also include transmitting the global timing reference frame to the one or more secondary ECUs.

In any of the methods described herein, the method can further include determining a target position for the actuators controlled by the first ECU based on the global timing reference frame, where the target position describes both a position and a master velocity for each actuator.

In any of the methods described herein, the method can further include initiating actuator movement based on the determined target position.

Described herein are apparatuses (devices, systems, and the like) that can stop a rotary motion of a shaft. Such apparatuses can include an engagement pin and a brake disc configured to rigidly attach to a rotatable shaft. The brake disc can comprise a first engagement region configured to engage the engagement pin as the pin moves into the brake disc, where the first engagement region can engage the pin with a first amount of backlash. The brake disc can further comprise a second engagement region configured to receive the engagement pin from the first engagement region, where the second engagement region can engage the pin with a second amount of backlash that is less than the first amount of backlash. Note that in any of the apparatuses described herein the multi-stage notched brakes described herein could be used with rotational or linear actuators.

In any of the apparatuses described herein, the first engagement region can comprise a first engagement pin receiving region disposed circumferentially around the brake disc, and the second engagement region can comprise a first notch configured to receive the engagement pin, disposed at an end of the first engagement region.

In some examples, the second engagement region can further comprise a second notch disposed at an opposite end of the first engagement region with respect to the first notch.

In any of the apparatuses described herein, the first engagement region can be disposed over a first circumferential amount, and the second engagement region can be disposed over a second circumferential amount that is less than the first circumferential amount.

In any of the apparatuses described herein, the first engagement region can be configured to engage with the engagement pin before the second engagement region engages with the engagement pin.

In some examples, the first engagement region can be a first disk with a first cutout, and the second engagement region can be a second disk with a second cutout, where the first disk is configured to rigidly attach to the second disk.

In any of the apparatuses described herein, the first cutout and the second cutout can be radially disposed around an outer circumference of the first disk and the second disk, respectively.

In some examples, the first engagement region can be configured to be two or more times as wide as the engagement pin, and the second engagement region can be configured to be less than two times as wide as the engagement pin.

In any of the apparatuses described herein, the second cutout can be configured to align with one end of the first cutout. In some examples, the engagement pin can be cylindrically shaped. In still other examples, the engagement pin can be actuated by an electrical solenoid.

In any of the apparatuses described herein, the electrical solenoid can be configured to engage the engagement pin into the brake disc upon loss of power to the electrical solenoid. In some examples, the brake disc and the engagement pin can be formed from high tensile steel.

For example, described herein are apparatuses for stopping motion of a drive shaft, the apparatus comprising: an engagement pin configured to move in a proximal to a distal direction; and a multi-stage notched brake disc configured to rigidly attach at a distal region of the drive shaft, the multi-stage notched brake disc comprising: a first engagement region comprising one or more first notches each having a first notch channel configured to engage the engagement pin as the engagement pin moves into the brake disc; and a second engagement region comprising one or more second notches each having a second notch channel configured to receive the engagement pin from the one or more first notches, wherein the first notch channel is longer than the second notch channel.

The first one or more notches may be positioned proximal to the second one or more notches (e.g., so that the pin contacts the first notch before moving into the second notch). The second notch channel may have a length configured to receive the engagement pin that is between 1× and 2× (e.g., between 100%-200% of) the outer diameter of the engagement pin and the first notch channel has a length configured to receive the engagement pin that is greater than twice (e.g., greater than 200%) of the outer diameter of the engagement pin. The second engagement region may comprises twice as many second notches as the number of first notches of the one or more first notches.

The first notch channel may be fluidly connected to two or more second notch channels. The first engagement region may be configured to engage with the engagement pin before the second engagement region engages with the engagement pin.

The first engagement region may be a first disk and the second engagement region may be a second disk rigidly attached to the first disk. The engagement pin may be actuated by an electrical solenoid. For example the electrical solenoid may be configured to engage the engagement pin into the multi-stage notched brake disc upon loss of power to the electrical solenoid. The brake disc and the engagement pin may be formed of any appropriate material, including from high tensile steel.

The engagement pin may be indirectly connected (e.g., through a linkage) to the electrical solenoid or directly connected.

The engagement pin may be spring-loaded such that its normal state is engaged with the brake disc.

For example, an apparatus for stopping motion of a drive shaft may include: a motor comprising the drive shaft; an engagement pin configured to move in a proximal to a distal direction; and a multi-stage notched brake disc rigidly attached at a distal region of the drive shaft, the multi-stage notched brake disc comprising: a first engagement region comprising one or more first notches each having a first notch channel configured to engage the engagement pin as the engagement pin moves into the brake disc; and a second engagement region comprising two or more second notches each having a second notch channel configured to receive the engagement pin from the one or more first notches, wherein the first notch channel is longer than the second notch channel, and wherein the first notch is positioned proximal to the second notch.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 schematically illustrates an overview of a system for synchronizing wheel alignment actuators as described herein.

FIG. 2 shows an example vehicle application synchronizing three actuators on one wheel.

FIG. 3 shows an example of a pair of wheels each having one or more actuators that may be synchronized as described herein.

FIG. 4 shows an example having six actuators on two wheels that may be synchronized as described herein.

FIG. 5 schematically illustrates an overview of a system for synchronizing wheel alignment actuators as described herein.

FIG. 6A is a block diagram of a global system.

FIG. 6B schematically illustrates the processes performed within individual ECUs when synchronizing across two or more ECUs.

FIG. 7 shows a method for synchronizing multiple systems.

FIG. 8 shows another method for synchronizing multiple systems.

FIG. 9 shows a method for synchronizing multiple decentralized systems.

FIG. 10 shows another method for synchronizing multiple systems.

FIG. 11 shows another method for synchronizing multiple decentralized systems.

FIG. 12 shows another method for synchronizing multiple decentralized systems.

FIG. 13 shows a block diagram of an apparatus that may be one example of a local system, or any other feasible system, device, or apparatus described herein.

FIG. 14A shows a rotary actuator system.

FIG. 14B shows an example brake disc.

FIG. 15 shows another example brake disc.

FIGS. 16A and 16B show an example braking system.

FIGS. 17A and 17B show another example of a braking system.

FIG. 18A is a graph that shows speed vs travel for an example braking system.

FIG. 18B is a graph that shows speed vs time for an example braking system.

### DETAILED DESCRIPTION

Described herein are synchronization apparatuses and methods that may accurately maintain the position synchronization of two or more vehicle actuators during operation of the vehicle, including during high-dynamic driving. Actuators may adjust alignment of the tires, such as camber, castor and toe. Accurate synchronization is important because even a small amount of relative positioning error (e.g., synchronization error) can lead to unwanted effects in a vehicle, such as unintended steering.

The use of alignment actuators in a vehicle for high-dynamic driving, such as those described in U.S. Pat. Nos. 10,112,649, 11,565,752, 12,084,110, U.S. patent application Ser. No. 18/762,621, and U.S. patent application Ser. No. 18/249,056, previously incorporated by reference in their entirety, create unique challenges for synchronization. It has not been possible to synchronize the actuators using the traditional techniques, which generally rely on system design and signal processing techniques before runtime; this approach has not been successful because high-dynamic driving causes frequent and unpredictable disturbances from external loads. Therefore, it was necessary to develop a new method of synchronization as described herein, in which the master-slave relationship is not predetermined before runtime but is determined dynamically during runtime. Described herein are specific processes for calculating the synchronization function that must be followed to achieve sufficiently low synchronization error.

Specifically, the synchronization techniques described herein may solve a significant problem identified during vehicle testing using active wheel alignment (AWA) systems. For example, when using these wheel alignment actuators, which may adjust camber, castor and/or toe, often more than one actuator is used to control the alignment of a wheel. For example, one or two actuators might be used to control wheel camber, while another actuator is used to control wheel toe. Also, often there is coupling between wheel camber and wheel toe due to the kinematics of the native vehicle suspension, so that a change in wheel camber will cause a change in wheel toe unless a toe correction is made. Under these circumstances, any relative position error between these actuators (called synchronization error) would cause a so-called “toe deviation” (a deviation of wheel toe away from the ideal value), which would result in unintended steering of the vehicle.

Although this concept of synchronization applies to any axle (front or rear) in any vehicle, it can be especially pronounced in certain applications such as in a rear axle, or in a stiff axle. In both cases the sensitivity to even a very small toe deviation is high. In one test vehicle, for example, it was necessary to synchronize three actuators to less than 0.1 mm position error (measured in the toe link reference frame) at all times, and ideally less than 0.05 mm. Any error greater than 0.1 mm was immediately detected by test drivers and marked as unsatisfactory due to yaw disturbance to the vehicle.

The above description highlights the need for synchronization where there are multiple actuators applied to a single wheel, but equally synchronization can be necessary for actuators acting on different wheels in a vehicle. For example, in another application the synchronization techniques described herein can be used to synchronize two toe actuators, one on a left wheel of the vehicle and one on a right wheel. In that case, any synchronization error between those two actuators could also cause unwanted behavior and/or unintended steering of the vehicle. In general, the synchronization techniques described herein can be used to synchronize any two or more actuators anywhere on a vehicle.

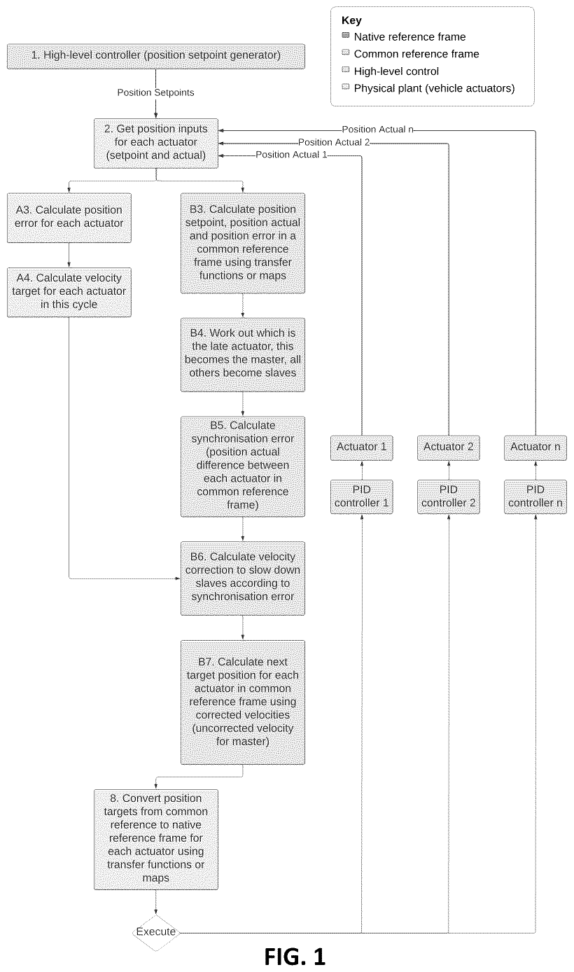

FIG. 1 schematically illustrates one example of a system for synchronizing two or more actuators. In FIG. 1, the block diagram illustrates the control process for synchronization for “n” number of actuators. As mentioned, these actuators may be any appropriate automotive actuator, and in particular an alignment actuator. In this example, the apparatus includes a high-level controller 1 that is also configured to be the position setpoint generator. That is, this controller determines the ideal position targets (setpoints) for all the actuators if synchronization, disturbance and dynamics are ignored. However, it is equally possible for block 2 or some other block to be the position setpoint generator without deviating from the present invention. What matters is that the apparatus (as shown in block 2) must know the position setpoint for each actuator in each calculation cycle.

In addition to the position setpoint values, block 2 must also know the actual position of each actuator at the present moment in time. These values may be measured with as little time latency as possible, ideally less than 10 ms ago, more ideally less than 5 ms ago, even more ideally less than 2.5 ms ago. Once the necessary inputs for block 2 are known, the calculation splits into two paths: native reference frame (path A) and common reference frame (path B).

In the native reference frame path (path A), the “native reference frame” means all information about each actuator is kept in the reference frame of the actuator to which it belongs. There is no transformation of position setpoint, position actual or any other values into another reference frame.

The first block in the native reference frame path is block A3. This block simply calculates the position error of each actuator as the difference between position setpoint and position actual. This position error for each actuator is then used as an input for block A4 to calculate the next velocity target for each actuator. Velocity targets can be open loop and can be calculated via equations of motion or via a gain scheduler. The purpose of the velocity target is to generate a path for each actuator to follow over time which respects the dynamics of the actuator (e.g. achievable speed, acceleration and deceleration, ignoring external disturbances). Paths must be planned for all actuators in all calculation cycles. These velocity targets may then be fed as inputs into block B6 (described in greater detail below).

The common reference frame (path B) shown in FIG. 1 includes a first block in path B referred to as B3. For any actuators that should be position synchronized, this block transforms their position setpoint and position actual values into a common reference frame. The common reference frame could be the reference frame of one of the actuators (e.g. the toe actuator for a given wheel), or any arbitrary reference frame. What matters is that the position setpoint and position actual values of all actuators to be synchronized are expressed in the same reference frame (same coordinate system and same units). All constants and variables used in all path B blocks may be expressed in the common reference frame.

Transforming actuator values into a common reference frame may require a map, transfer function or transformation matrix. This is normally a constant and is determined before runtime, e.g. from the kinematics of the vehicle's suspension. It is not necessary to use the same common reference frame with each calculation cycle. In one embodiment the reference frame of the “master actuator” (see below for definition) in each calculation cycle is made to be the common reference frame. Once all position setpoint and position actual values are expressed in a common reference frame, the position error for each actuator may be calculated the same way as in block A3 (position setpoint minus position actual), except this time the error is in the common reference frame. This position error for each actuator in the common reference frame can then be used in block B4 to work out which is the “late actuator,” meaning which actuator is furthest from its position setpoint. The late actuator is then designated as the master (e.g., “leader”), and all other actuators to be synchronized are designated as the slaves (e.g., “followers”). Block B5 then calculates a set of different error values, which are the synchronization errors. This is the difference in position actual between each slave actuator and the master actuator in the common reference frame. For example, if actuator 1 was the master:

$$syncError\_ 2 \_ 1 = positionActual\_ 2 - positionActual\_ 1$$

$$syncError\_ 3 \_ 1 = positionActual\_ 3 - positionActual\_ 1$$

$$etc .$$

These synchronization errors are then used in block B6 to make velocity corrections to the velocity targets calculated in block A4. Velocity corrections are only made to the slave actuators to slow them down (to allow the master actuator to catch up). The velocity corrections can be calculated using a mathematical controller, such as a proportional (P), proportional-integral (PI) or proportional-integral-derivative (PID) controller.

The corrected velocities for the slaves, and the uncorrected velocity for the master, are then used in block B7 to calculate the next position target for each actuator in the common reference frame. In this way, all actuators are calculated to follow the same path in the common reference frame plus a deviation for the velocity correction. So, if the synchronization error is zero and therefore the velocity correction is zero, the position target for each actuator in the common reference frame may be the same. This means the synchronization logic may include essentially: synchronize using a common position target in a common reference frame, and a velocity correction to the slave actuators to promote re synchronization.

Back to the native reference frame, the position target for each actuator in the common reference frame is then transformed to a position target in the given actuator's native reference frame. After this, the position target for each actuator is sent to a standard PID position controller, which controls the actuator. This completes one full calculation cycle.

As noted above, any reference frame can be used as the common reference frame for the present invention, for example, it can be the reference frame of one actuator or an arbitrary reference frame. The preferred embodiment is to use the reference frame of the master actuator as the common reference frame, as it is easier to tune and calibrate the gains in the reference frame that is most relevant to what is trying to be achieved. This means that, under this embodiment, with each calculation cycle the common reference frame may change, it is not fixed.

Considerable efforts were made to create control models other than the one presented above, such as synchronizing only with velocity corrections (no common position path over time), or synchronizing only with a common position path over time (no velocity corrections). However, these alternative attempts were unsuccessful at achieving the required level of synchronization error with dynamic loading (external disturbance). Therefore, it is necessary to implement the method as described above, with a common position path over time plus velocity corrections.

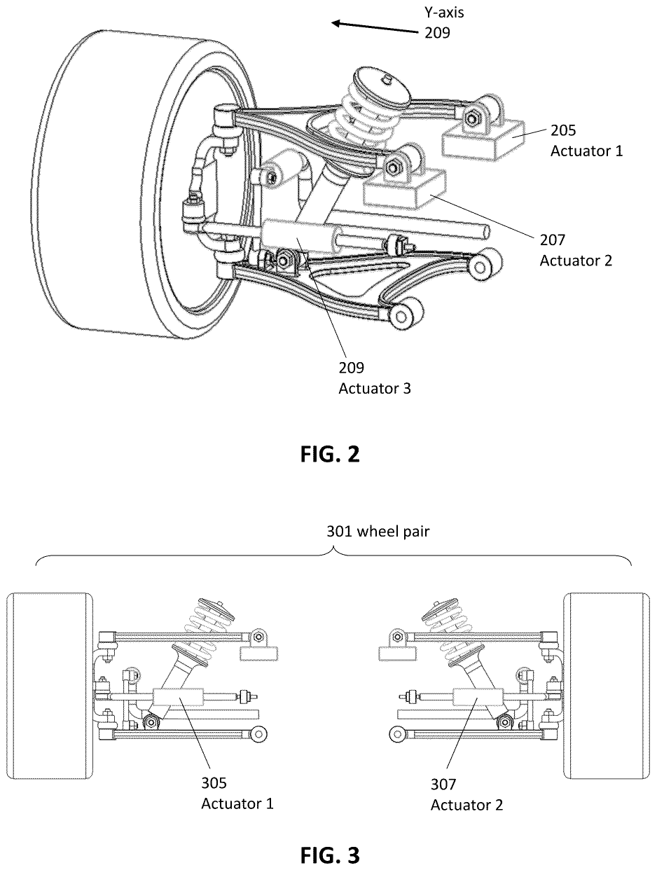

FIG. 2 shows an example application of the present invention. There are three actuators located at a single wheel of a vehicle. All actuators are configured to cause a displacement generally in the y-axis 209 as shown. The purpose of actuators 1 205 and 2 207 in this example (though alternative actuators may be used) are to control camber and/or castor of the wheel (via the upper control arm), while the purpose of actuator 3 209 is to control the toe of the wheel. Due to the kinematics of the suspension layout, any change to the position of actuators 1 or 2 will cause a change in wheel toe. To maintain the desired (unchanged) wheel toe, it is necessary to make a corrective position adjustment to actuator 3.

For the purposes of this example, assume that a camber change is requested so that actuators 1 205 and 2 207 will move towards the positive y-direction. To maintain the wheel toe (unchanged), actuator 3 209 may also move towards the positive y-direction by a certain amount. If there is no external load, so that external disturbance can be ignored, a simple coupling relationship between the actuators can be applied to calculate the needed movement of actuator 3 over time. This coupling relationship can be obtained from the kinematic model of the suspension.

However, if unpredictable external loads are introduced, such that each actuator sees a different and time-varying load, one actuator may momentarily slow down while the others continue to move freely, causing a synchronization error. Assume for example, actuator 1 sees a high load while actuators 2 and 3 do not. Actuator 1 slows down, while actuators 2 and 3 continue to move at full speed, and there will be a wheel toe deviation because actuator 3 has applied a toe correction that is too high. Without synchronization, actuator 3 does not know that actuator 1 has slowed down, and likewise actuator 2 will be out of sync with actuator 1 for the same reason.

Now assume that moments later the external loads have changed, and actuators 1 and 2 see low loads, while actuator 3 sees a high load and slows down. Now the “master” actuator (the late actuator) has shifted from actuator 1 before to 3 now. In this way, it is not possible to determine the master and slaves before runtime, they must be determined dynamically during runtime. The present invention takes care of this and effectively synchronizes all three actuators in this example over time by: determining which actuator is the master (slow actuator) for each calculation cycle at runtime; and implementing a control strategy to synchronize the slave actuators to the master actuator at each calculation cycle.

FIG. 3 shows another example of a vehicle application. In this example it is desired to synchronize actuators located on different wheels 301 in a vehicle. For this example, assume that it is desired to synchronize the wheel toe between a left wheel and a right wheel of the vehicle. Actuator 1 305 controls the wheel toe of the left wheel, and actuator 2 307 controls the wheel toe of the right wheel. Again, in the absence of external load disturbance position synchronizing the two actuators could be achieved by knowing their relative kinematics. However, if actuator 1 sees a high external load and slows down while actuator 2 sees only a low load and does not slow down, synchronization will be lost and the position deviation will occur.

Under the present invention, at each calculation cycle it is determined which of actuator 1 and 2 is the master (slow actuator) and which is the slave. The slave actuator is then synchronized to the master actuator using the method described above (common position path plus velocity correction). In general, it is possible to synchronize two or more actuators located on one or more wheels of a vehicle. In another example, it may be desired to synchronize three actuators located at a single wheel, and to also synchronize one of those actuators with an actuator located on another wheel of the vehicle.

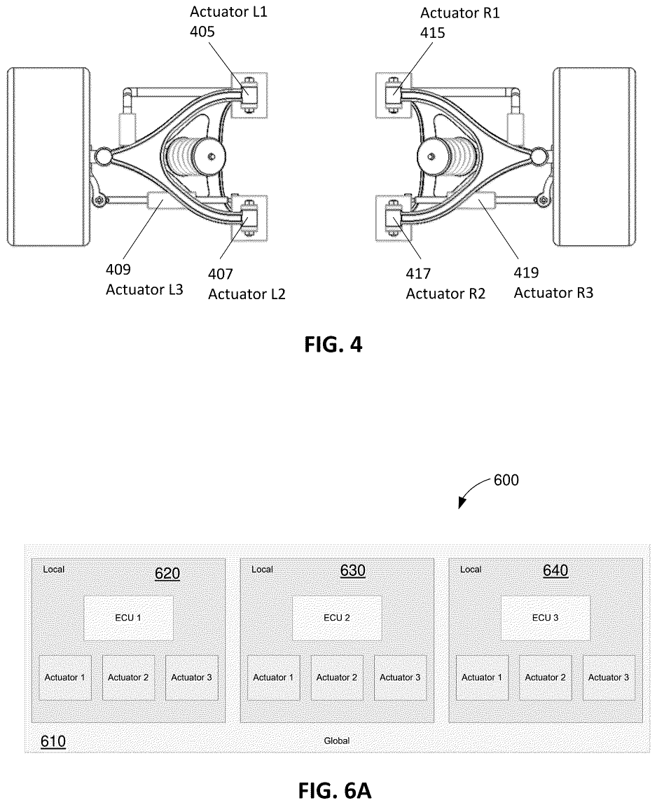

FIG. 4 shows an example vehicle application with six actuators in total, three located on a left wheel and 3 located on a right wheel. In this example, it is desired to synchronize: actuators L1 405, L2 407 and L3 409 together for the left wheel; actuators R1 415, R2 417 and R3 419 together for the right wheel; and/or actuators L3 409 and R3 419 together (e.g. for control of total wheel toe).

The present invention can be applied to this situation with the same process as described above. In the case that different synchronization accuracy is needed for each actuator pairing, the control gains can be independently tuned to achieve this. In some applications it may be necessary to both synchronize actuators and allow some freedom for a synchronized actuator to be deviated on command. For example, in a vehicle application such as the one shown in FIG. 4, it may be necessary to synchronize actuators L1, L2 and L3 together, and to also allow actuator L3 to deviate on command. An example where this might be needed is for steering applications, such as rear wheel steering. In such a situation, actuator L3 has two roles to play. It must apply corrective toe adjustments to compensate for the wheel toe changes caused by actuators L1 and L2, and also apply toe adjustments for wheel steering on-command from a high-level vehicle controller.

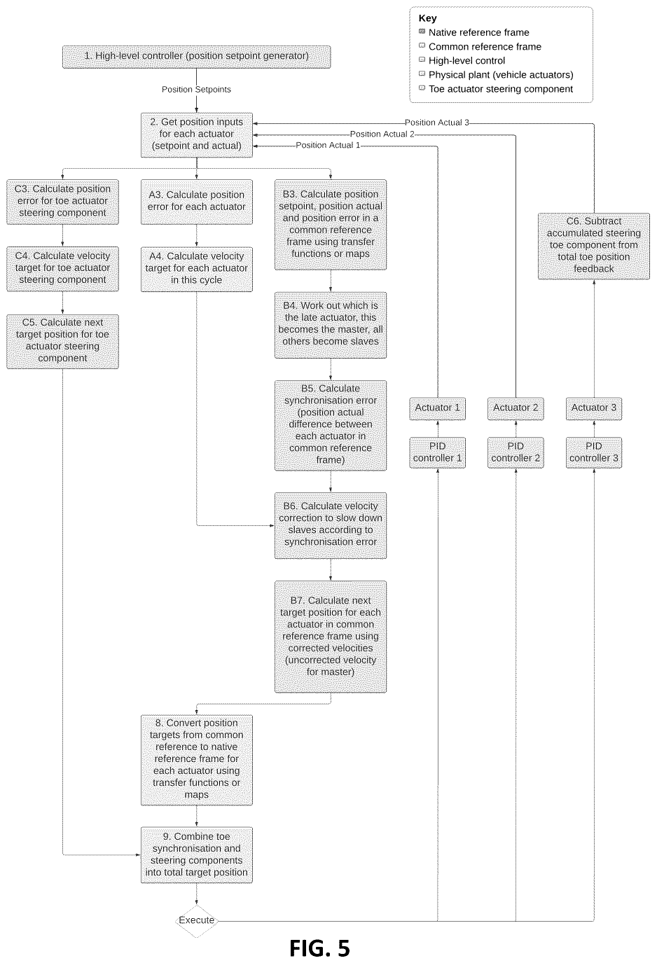

FIG. 5 shows the block diagram for an example vehicle application where one actuator is allowed to deviate on command. In this example, actuators 1 and 2 provide camber and/or castor control of a wheel on a vehicle, and actuator 3 provides toe control. When actuators 1 or 2 change position they cause a change in wheel toe. Actuator 3 must correct for this change in wheel toe and also provide wheel steering on-command such as for rear wheel steering. Referring to the block diagram, it is the same as for the invention described in FIG. 1 with the addition of one extra path and five extra blocks. The new path is path C, which handles the calculation and control of the toe steering component. The total position (or total toe) of actuator 3 can be split between the synchronization component and the steering component. This is calculated in block C6, where the accumulated steering toe component is subtracted from the total toe position feedback. This allows the position actual value of actuator 3 to be input into block 2 in two components: position actual 3, synchronization component; and position actual 3, steering component.

The toe synchronization component is then passed to blocks A3 and B3 to feed those paths, and the toe steering component is passed to block C3 to feed path C. Block C3 then calculates the position error for the toe steering component as the difference between the toe steering setpoint (from the high-level controller) and steering component of position actual 3.

This position error from block C3 is then used as an input for block C4 to calculate the next velocity target for the toe steering component. The velocity target can be open loop and can be calculated via equations of motion or via a gain scheduler. The purpose of the velocity target is to generate a path for the toe steering component of actuator 3 to follow over time that respects the dynamics of the actuator (e.g. achievable speed, acceleration and deceleration, ignoring external disturbances).

The velocity target calculated in block C4 is then input to block C5, where the next position target for the toe steering component is calculated. Lastly, this toe steering position target is then input to block 9 to sum together the position targets for the toe steering and toe synchronization components. As usual, all targets are then sent to the actuators via standard PID controllers, and the cycle repeats. In this way, it is possible to accurately synchronize multiple actuators across one or wheels on a vehicle, while allowing an additional degree-of-freedom for on-command steering overlay.

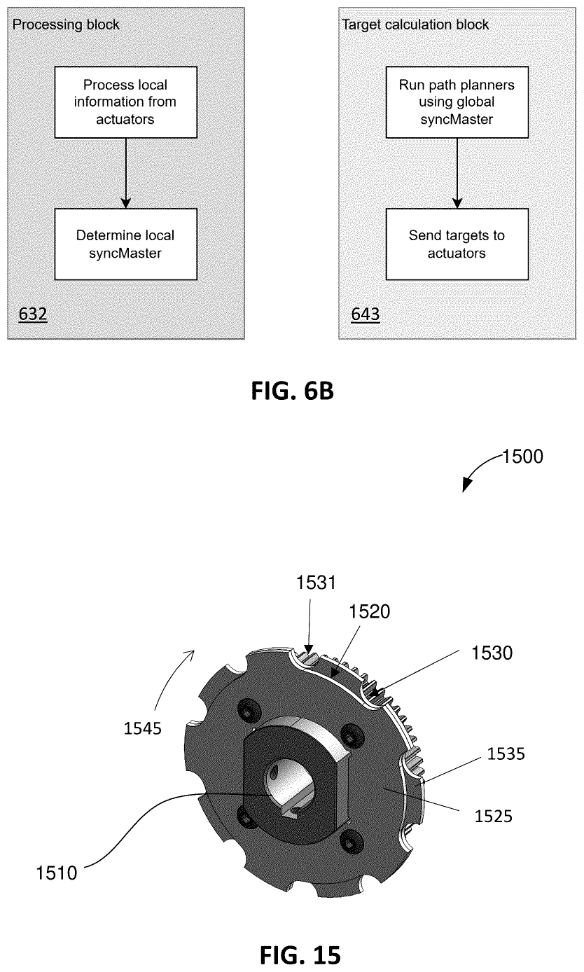

FIG. 6A is a block diagram of a global system 600. The global system 600 can be associated with a global system that further includes two or more local systems. In the example global system 600 of FIG. 6A, the global system 600 can include a first local system 610, a second local system 620, and a third local system 630. While the global system 600 is shown with three local systems, in other implementations, the global system 600 can include any feasible number of local systems.

Each local system within the global system 600 can include a number of actuators and an ECU to control the actuators. For example, local system 620 can be associated with a left front wheel. Thus, the actuators of local system 620 can control the left front wheel's caster, camber, toe-in, toe-out or the like. Similarly, the local system 610 and the local system 630 can be associated with other systems or sub-systems of a vehicle. For example, any of the local systems 610, 620, and 630 can control front or rear wheel steering geometry as well as front or rear wheel suspension geometry.

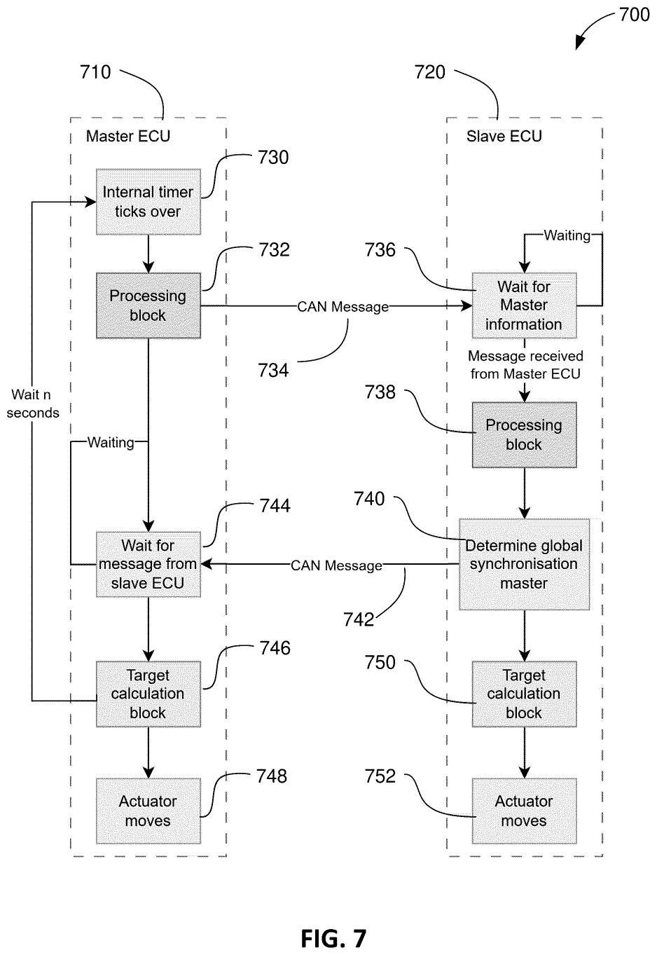

Any of the ECUs in any of the local systems described herein can control their associated actuators as described with respect to FIG. 5. For example, the ECU within the local system 610 can synchronously control and actuate actuators within the local system 610. However, if operations of the local systems 610, 620, and 630 are not synchronized, then the associated actuators can adjust systems independently, potentially causing a vehicle to be configured in a poor or unsafe manner. FIG. 6B schematically illustrates a general organization for synchronization across two or more ECUs. For example, for each iteration of a synchronization process within each ECU, two sets of calculations may be completed and applied within each of a processing module (e.g., “processing block”) 632 and a target calculation module (e.g., “target calculation block”) 646. In FIG. 6B these modules (which may be conceptual regions of the ECU and/or may be actual partitioned regions) are shown. The processing module may be configured to use (and in some cases may only or exclusively use) local information, e.g., that does not include information from any other ECU in the apparatus, whereas the target calculation module may be configured to use information about the globalization synchronization master (e.g., using information from some or more preferably, all, other ECUs to be synchronized together). Described herein are a variety of different implementations or embodiments that can embody this arrangement, as illustrated in FIGS. 7-12. For example, FIGS. 7-12 describe various approaches to synchronizing the operation of multiple local systems, in particular synchronizing multiple systems controlled by separate ECUs. In general, the features of any one or more of these embodiments may be incorporated into any of the other embodiments, unless the context indicates otherwise.

FIG. 7 shows a method 700 for synchronizing multiple systems. This example shows a system including synchronization between two ECUs, without the need for a global timer. The method 700 can synchronize a global system, such as the global system 600 and can include any number of local systems. As shown, the method 700 can synchronize operations of a first local system 710 and a second local system 720. In this example, the first local system 710 can be referred to as a master ECU and the second local system 720 can be referred to as a slave ECU. Each local system can include an ECU and one or more actuators (not shown). The static master EU and the static slave ECU may be determined (as described herein) prior to the start of a calculation cycle. In FIGS. 7-12 the blocks referred to may be modules.

Operations between the first local system 710 and the second local system 720 can be synchronized through the transmission and reception of certain messages. For example, the method can begin in block 730 where the master ECU waits for an internal timer to expire. For example, the internal time can count down a predetermined time period. The predetermined time period can control, to some extent, how often the local systems are synchronized and how often the local systems move their associated actuators. In some cases this configuration does not require a global timer or CAN ‘go’ message in order to trigger the start of the processing module for each ECU, which may be advantageous.

Next, in block 732 the master ECU performs local processing operations. The local processing operations can include determining actual and target actuator positions controlled by the master ECU. In addition (or alternatively) the master ECU can determine an error between actual and target actuator positions. Further, the master ECU can determine a relative error between each actuator controlled by the master ECU. This relative error can be used to determine the relatively slowest actuator in the master ECU. This data can be used to generate a local timing reference frame. Thus, the local timing reference frame can include data that describes how the actuators are moving as well as which of the actuator may be the “pacing” actuator. The pacing actuator may be setting the overall pace of actuator motion which may be driven by the slowest actuator. In some implementations, the local timing reference frame can be a data structure.

Next, in this example, the local timing reference frame is transmitted 734 to the slave ECU. In some examples, the local timing reference frame can be transmitted as a controller area network (CAN) message on a CAN bus connected between the master ECU and the slave ECU. Any other suitable form of inter-ECU communication may be used, for example Flexray, Ethernet, serial, SPI, I2C or the like.

The slave ECU can be waiting for the message (the local timing reference frame) from the master ECU in block 736. After receiving the message in block 736, the slave ECU can perform local processing operations in block 738. Similar to the local processing operations performed by the master ECU, the slave ECU can determine an error between actual and target actuator positions and determine a relative error between each actuator controlled by the slave ECU. This relative error can be used to determine the relatively slowest actuator in the slave ECU.

At this point the slave ECU has both local (slave) and remote (master) timing reference information. Next, in block 740 the slave ECU can determine a global timing reference frame. The global timing reference frame can be used by both ECUs in this system. In some examples, the global timing reference frame can be based on the relatively slowest actuator in both the master ECU and the slave ECU. In some other examples, the global timing reference frame can include an actual position of the slowest actuator, a position setpoint of the slowest actuator, and a velocity of the slowest actuator. In some cases, the global timing reference frame can be a data structure. The global timing reference frame is transmitted to the master ECU in block 742. In some examples, the global timing reference frame is transmitted as a CAN message over a CAN bus to the master ECU.

The master ECU has been waiting for the message in block 744. In some examples, the master ECU entered block 744 from block 732. Next, the master ECU performs target calculations for actuators within the master ECU in block 746. The target calculations can determine settings (positional targets and/or velocities) for any actuators controlled by the master ECU. In some examples, an algorithm to determine a target position for each actuator may be based on a global synchronization master actual position, a global synchronization master setpoint position, a global synchronization master velocity, a local actuator position, and a local actuator setpoint. As noted above, the global synchronization master actual position, global synchronization setpoint position, and global synchronization master velocity may be related to or associated with the slowest actuator being controlled.

Next, the method can return to block 730 and also proceed to block 748 in parallel where the master ECU moves the actuators. In some cases, block 748 can initiate motion for one or more actuators based on the target calculation of block 746. Notably, operations of the block 730 are based only on the completion of block 746. That is, the method can wait for the timing while independently moving one or more actuators. Actuator movement can advantageously be decoupled from the timer of block 730.

Returning to block 740, after the global timing reference frame is determined, then in block 750, the slave ECU performs target calculations for actuators controlled by the slave ECU. Operations for block 750 can be similar to the operations described with respect to block 746. That is, both block 746 and block 750 can use the global timing reference frame to determine how (velocity and/or setpoint) to operate any of the actuators. Next, in block 752 the slave ECU moves one or more actuators it controls.

The example shown in FIG. 7 may be used, for example, to synchronize between at least two ECUs, for example to synchronize across two wheels of an axle, in which one ECU may be is used to control one or more actuators on each wheel, and the left and right wheels are to be synchronized, to avoid unintended steering due to toe angle deviations left-to-right. This implementation can be achieved as describe above and illustrated in FIG. 7.

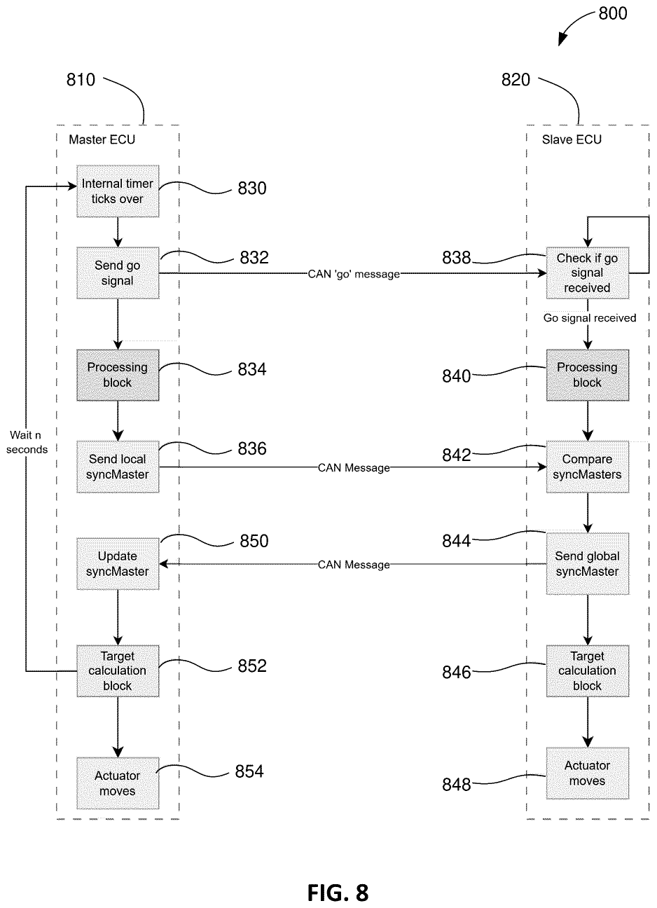

In another example, a global timer can be used to initiate actions and/or synchronization of two or more local systems. An example method is described with respect to FIG. 8.

FIG. 8 shows another method 800 for synchronizing multiple systems. As shown, the method 800 can synchronize operations of a first local system 810 and a second local system 820. In this example, the first local system 810 can be referred to as a master ECU and the second local system 820 can be referred to as a slave ECU. Each local system can include an ECU and one or more actuators (not shown). In FIG. 8, the example may include a global timer with a CAN ‘go’ message to trigger the start of the processing module for each ECU.

The method and apparatus shown in FIG. 8 may begin in block 830 where the master ECU waits for an internal timer to expire (similar to as described for block 730 of FIG. 7). Next, in block 832, the master ECU can send a “go” signal to the slave ECU. The go signal can be a CAN message transmitted over the CAN bus to the slave ECU. In some examples, the go signal can be a broadcast message transmitted over the CAN bus. The go signal can initiate some operations in the slave ECU as will be discussed with respect to block 838.

In block 834, the master ECU performs local processing operations to determine a local timing reference frame. Operations of block 834 can be similar to the operations described with respect to block 732. Next, in block 836, the master ECU can transmit the local timing reference frame to the slave ECU. In some examples, the local timing reference frame can be transmitted as a CAN message over the CAN bus.

Returning to block 838, the slave ECU can wait until the slave ECU receives the go message from the master ECU. Next, in block 840 the slave ECU performs local processing operations to determine a local timing reference frame, similar to as described with respect to block 834, but with respect to actuators controlled by the slave ECU.

Next, in block 842, the slave ECU can receive the local timing reference frame from the master ECU and determine a global timing reference frame. Since the slave ECU has the local timing reference from the master ECU and its own local timing reference frame, the slave ECU can compare the frames and determine the global timing reference frame. The global timing reference frame can be similar to the global timing reference frame described with respect to FIG. 7. In some cases, the global timing reference frame can be determined from the local timing reference frames as described with respect to block 740 and include information about the relatively slowest actuator controlled by the master ECU and the slave ECU.

Next, in block 844 the slave ECU can transmit the global timing reference frame to the master ECU. In some examples, the global timing reference frame can be transmitted as part of a CAN message. Next, in block 846 the slave ECU can perform target calculations for actuators controlled by the slave ECU similar to block 750 of FIG. 7. Next, in block 848 the slave ECU moves actuators. For example, the slave ECU can move actuators as determined in block 846.

Returning to block 844 as the slave ECU transmits the global timing reference frame to the master ECU, then in block 850 the master ECU receives the global timing reference frame. Next, in block 852 the master ECU performs target calculations. Target calculations can determine position setpoints and velocities for actuators controlled by the master ECU based on the global timing reference frame.

Next, in block 854 the master ECU moves actuators in a manner as determined in block 852. Returning to block 852, the method can return to block 830 as the master ECU waits for the global timer to elapse.

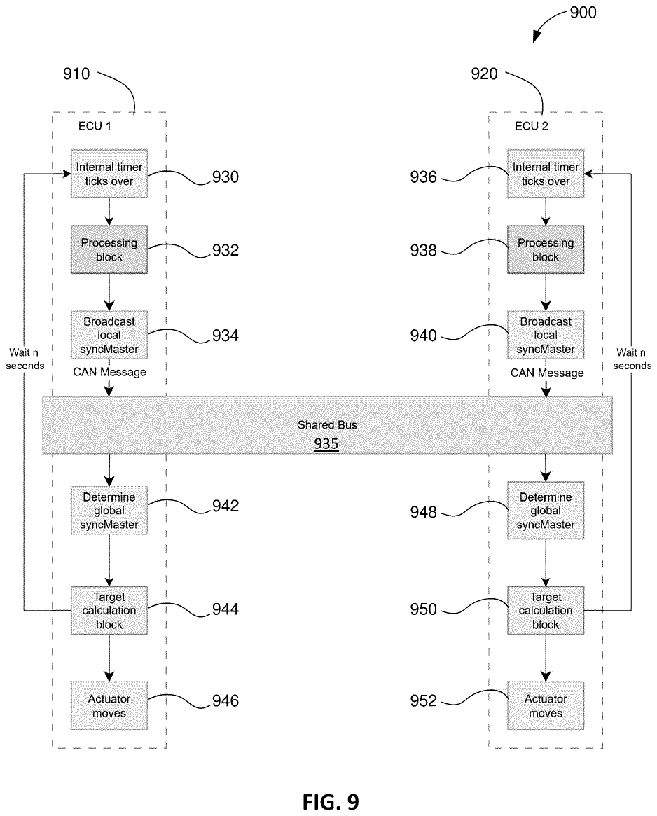

FIG. 9 illustrates an example of a method 900 for synchronizing multiple systems. In this example, the method 900 can synchronize operations of a first local system 910 and a second local system 920. Each local system can include an ECU and one or more actuators (not shown). As described in detail below, there is no concept of slave or master ECU, but instead both ECUs can share information and synchronize operations.

The method begins in block 930 where the first local ECU 910 waits for an internal timer to expire (similar to operations of block 730 of FIG. 7). After expiry of the timer, in block 932 the first local ECU 910 performs local processing operations to determine a first local timing reference frame. Operations of block 932 can be similar to the operations described with respect to block 732. Next in block 934, the first local ECU 910 can transmit or broadcast the first local timing reference frame to other ECUs. In some examples, the first local timing reference frame is broadcast over a shared bus 935. In some embodiments, the shared bus 935 can be a CAN bus.

Turning now to the second local ECU 920, in block 936 the second local ECU waits for an internal timer to expire. After expiry of the timer, in block 938 the second local ECU 920 determines a second local timing reference frame. Next, in block 940 the second local ECU transmits or broadcasts the second local timing reference frame to other ECUs on the shared bus 935.

At this point, all ECUs have access to the local timing reference frames for all other ECUs as well as their own. Turning to the first local ECU 910, in block 942 the first local ECU 910 determines the global timing reference frame from available local timing reference frames. Next, in block 944 the first local ECU 910 performs target calculations for actuators controlled by the first local ECU 910 based on the global timing reference frame. The method 900 can return to block 930 and also proceed to block 946 in parallel and move actuators based on the target calculations of block 944.

Returning to the second local ECU 920, in block 948 the second local ECU 920 determines the global timing reference frame from available local timing reference frames (which should be the same as the global timing reference frame determined by the first local ECU 910 in block 942). Next, in block 950 the second local ECU 920 performs target calculations and can return to block 936 and also proceed to block 952 in parallel and move actuators based on the target calculations of block 950.

For synchronization method 900, the first local ECU 910 and second local ECU 920 may host identical base software and may function as a distributed network, e.g., and do not require a master/slave assignment.

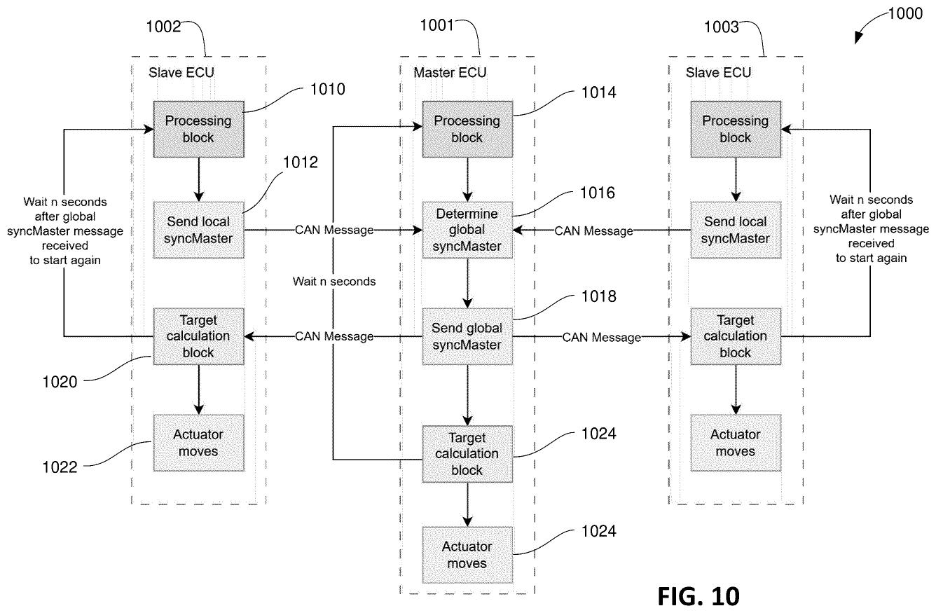

In general, the synchronization techniques described herein can be expanded to include any feasible number of systems. In some examples the methods and apparatuses described herein may be configured to synchronize across three or more ECUs by extending the implementations used for two ECUs (e.g., in a master-slave configuration), but with multiple slaves. For example, FIG. 10 shows a method 1000 for synchronizing multiple systems. In this example a system can include a first local system 1001 (also referred to as a master ECU), a second local system 1002 (also referred to as a first slave ECU) and a third local system (also referred to as a second slave ECU).

The method 1000 shown in FIG. 10 begins in block 1010 where the first slave ECU performs local processing operations to determine a first local timing reference frame. Operations of block 1010 can be similar to those described with respect to block 732. Next, in block 1012 the first slave ECU transmits the first local timing reference frame to the master ECU. In some examples, the first slave ECU can transmit or broadcast the first local timing reference frame to the master ECU through a shared bus, such as a CAN bus.

In parallel to the operations of the first slave ECU, the second (or more) slave ECU performs the same operations as the first slave ECU and transits its local timing reference frame (the second local timing reference frame) to the master ECU.

Turning now to the master ECU, in block 1014 the master ECU performs processing operations to determine a third local timing reference frame. Next, in block 1016 the master ECU determines the global timing reference frame. At this point the master ECU can access all the local timing reference frames for all available systems. Although not explicitly described, the second local ECU can also determine its local reference frame and transmit or broadcast it to the master ECU. Since the master ECU has access to all the local timing reference frames, the master ECU can determine the global timing reference frame from the available local timing reference frames.

Next, in block 1018 the master ECU transmits or broadcasts the global timing reference frame to other systems such as the first slave ECU and the second slave ECU. The first slave ECU receives the global timing reference frame at block 1020. Next, in block 1020 the first slave ECU performs target calculations to determine settings for actuators controlled by the first slave ECU based on the global timing reference frame. The method returns to block 1010 as well as moving actuators in block 1022.

In parallel to the operations of the first slave ECU in block 1020 and block 1022, the second slave ECU performs the same operations to move the actuators it controls.

Returning to the master ECU, after transmitting or broadcasting the global reference timing frame in block 1018, the master ECU performs target calculations to control actuators controlled by the master ECU in block 1024. The method 1000 returns to block 1014 and also proceeds to block 1024 to move actuators based on the target calculations.

In another example, each ECU-based system can be identical. That is, no one local system can be a master system, instead all local systems can participate in synchronizing the local system in a decentralized fashion. This configuration and techniques may be applied (e.g., as a master-slave implementation) for three or more ECUs without departing from the overall concepts described herein.

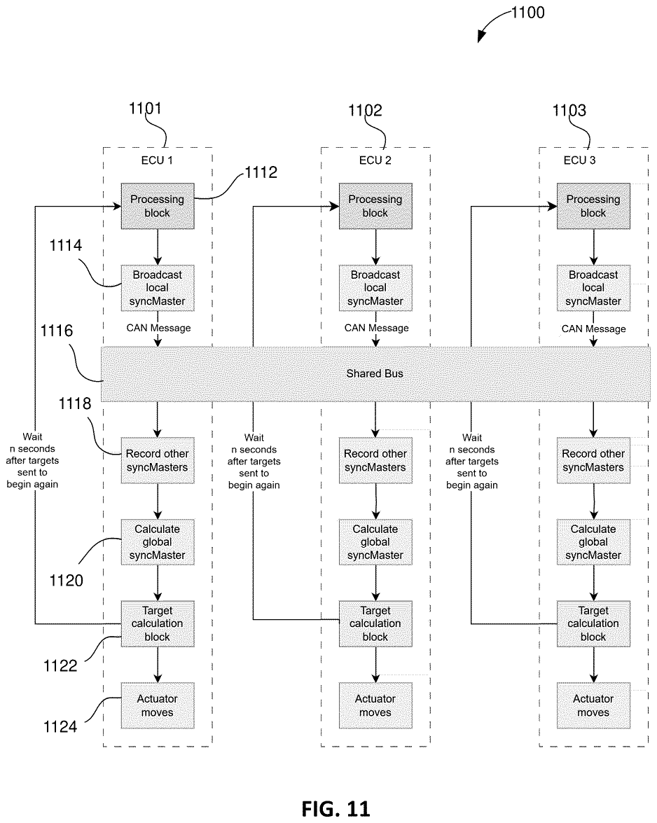

FIG. 11 shows a method 1100 for synchronizing multiple ECUs using a decentralized configuration. The method 1100 can synchronize any feasible number of local systems although FIG. 11 shows three systems. For example, FIG. 11 shows a first local system 1101, a second local system 1102, and a third local system 1103. The method 1100 is described from the viewpoint of the first local system 1101, however those skilled in the art can appreciate extending the method 1100 to cover any number of systems.

In the example process flow shown in FIG. 11, each ECU may first wait a defined period of time after the last set of position targets were actioned before commencing the next calculation cycle. Once this time period has elapsed, each ECU may run its processing module and may broadcast its local information on the CAN bus. Standard CAN protocol arbitration may be used to determine the order of messages loaded onto the bus. All ECUs may listen to all messages broadcast on the bus in order to capture the local information of all other ECUs. Once all ECUs have broadcast their local information on the CAN bus, and all ECUs have received the local information of all other ECUs, each ECU may independently determine the global synchronization master and then executes the target calculation module. One advantage of this setup is that all ECUs can be programmed the same way.

The method 1100 can begin in block 1112 where the first local system 1101 (sometimes referred to as an ECU) performs processing operations. Similar to as described with respect to block 732 of FIG. 7, the ECU can determine actual and target actuator positions, determine an error between actual and target actuator positions, and determine a relative error between each actuator controlled by the ECU. The first local system 1101 can also generate a local timing reference frame based on this data.

Next, in block 1114, the first local system 1101 transmits or broadcasts its local timing reference frame to other local systems. In some examples, the local timing reference frame can be transmitted on a shared bus 1116, such as a CAN bus.

Next, in block 1118, the first local system 1101 receives the local timing reference frames from all other systems. These local timing reference frames can be received through the shared bus 1116.

Next, in block 1120, the first local system 1101 can determine a global timing reference frame. Because the first local system 1101 has access to the local timing reference frames from all other systems, the first local system 1101 can determine the global timing reference frame. (Notably, from the point of view of any other system, each system also has access to all the local timing reference frames. Therefore, each system can independently determine or calculate the global timing reference frame.)

Next, in block 1122, the first local system 1101 performs target calculations to move actuators according to the global reference timing frame. The method returns to block 1112 and also proceeds to block 1124 where the first local system 1101 moves actuators according to the target calculations.

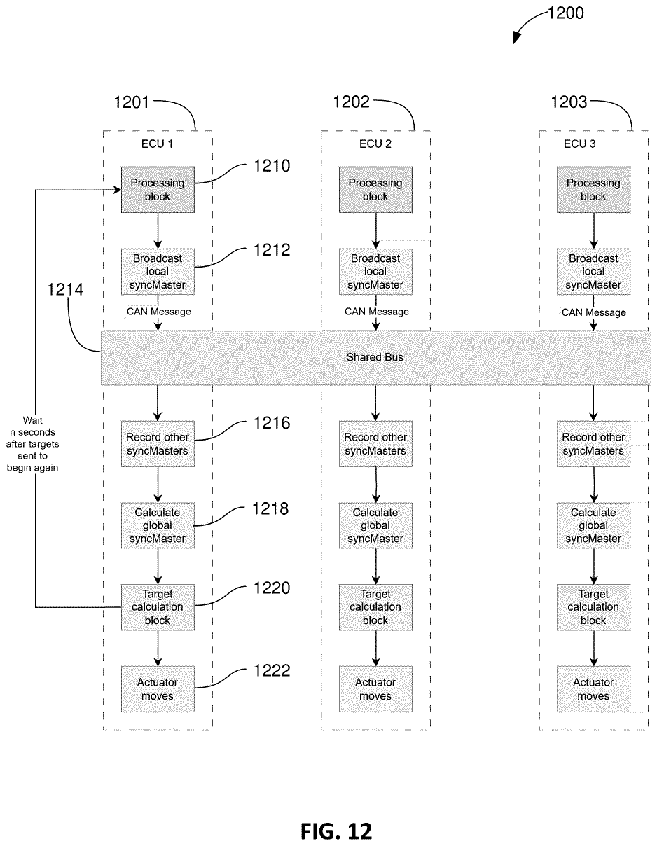

In some examples, each of the local systems can be synchronized with respect to when each transmits their local timing reference frame to the other local systems. This is described below with respect to FIG. 12.

FIG. 12 shows a method 1200 for synchronizing multiple systems. In the example of FIG. 12, three local systems are shown, but those skilled in the art will appreciate that the method 1200 can be extended to synchronize any feasible number of local systems. Generally, as each local system determines its own local timing reference frame, each local system can transmit or broadcast its local timing reference frame to the other local systems. From the point of view of a particular local system, the local system can operate with a “provisional” global timing reference frame. Initially, the provisional global timing reference frame can be the local system's own local timing reference frame. Then as other local timing reference frames are received, the local system can compare the received local timing reference frame to the provisional global timing reference frame and determine the next provisional global timing reference frame. The order that the local systems broadcast their local timing reference frame can be based on an arbitrary priority assigned to all the local systems. The example shown in FIG. 12 illustrates an alternative technique that may use “custom arbitration” in which all ECUs may be synchronized having an order of priority for broadcasting messages. In this approach the ECU with the lowest priority will broadcast first, while all other ECUs will listen to the message. Each ECU may keep a ‘provisional’ global synchronization master, which will be the synchronization master with the greatest error to that point. The provisional global synchronization master will always start as each ECU's local synchronization master, but as messages are received this will be updated. In this way, each ECU does not need to store all of the other synchronization masters, just the provisional global synchronization master. Each ECU will broadcast its message once the ECU before it has broadcasted its message. As such, each ECU will need to know its own priority, and the number of total ECUs present in the system. Once all messages have been received, each ECU will execute its target calculation module.

For example, FIG. 12 shows a first local system 1201, a second local system 1202, and a third local system 1203. The method 1200 is described with respect to the first local system 1201, however those skilled in the art will appreciate extension of the explanation to cover the second local system 1202, the third local system 1203, and so on.

The method 1200 begins in block 1210 as the first local system 1201 performs local processing operations and determines a local timing reference frame. Next, in block 1212 the first local system 1201 can transmit or broadcast its local timing reference frame. In some examples, the local timing reference frame is transmitted through a shared bus 1214, such as a CAN bus. In some examples, transmission or broadcast of the local timing reference frame may be based on a pre-assigned priority order. For example, the first local system 1201 can transmit or broadcast its local timing reference frame first. Next, in priority order may be the second local system 1202. Thus, the second local system 1202 may transmit or broadcast its local timing reference frame after the first local system 1201. This priority-order transmission or broadcast may continue until all local systems have transmitted or broadcast their local timing reference frame. Advantageously, this ordered (and sequential) transmission of local timing reference signals may remove bus contention on the shared bus 1214.

Next, in block 1216, the first local system 1201 can receive any transmitted or broadcast local timing reference frames. Next, in block 1218 the first local system 1201 can determine a new global timing reference frame by comparing the current provisional global timing reference frame to the received global timing reference frame. The new global timing reference frame can be the timing reference frame with the most “error” or the one that describes the slowest actuator associated with any one local system.

Since not all local timing reference frames are available at the same time, the first local system 1201 only needs to “record” or store the last received local timing reference frame and the provisional global timing reference frame. After determining the new global timing reference frame, the last received local timing reference frame can be deleted or overwritten. This process may be continued until the local timing reference frames of all other local systems have been received by the first local system 1201, at which point the provisional global timing reference frame becomes the final global timing reference frame.

Next, in block 1220 the first local system 1201 can perform target calculations and determine settings for any actuators controlled by the first local system 1201. The method 1200 can return to block 1210, in some cases after waiting for a predetermined time period. The method 1200 can also proceed to block 1222 in parallel where the first local system 1201 can move actuators according to data from the target calculations performed in block 1220.

In general, the methods and apparatuses described herein may provide synchronization techniques that may be used across two, three or more ECUs, rather than just a single ECU. These techniques are particularly advantageous as compared to alternatives in that they are relatively simple, low-cost and significantly faster than existing techniques. The methods and apparatuses described may respond accurately within a few microseconds or faster when synchronizing across multiple different ECUs, which current systems, particularly those using cable-based communications, cannot achieve. Furthermore, the apparatuses and methods described herein can be realized with any number of ECUs, including 2, 3, 4 or more ECUs, without changing the underlying logic and structure. Thus, these apparatuses and methods allow two or more ECUs to reliably and quickly control more than one actuator, unlike existing systems, which cannot readily translate from 1:1 (ECU: actuator), by providing global and local synchronization. In any of these examples the methods and apparatuses may first synchronize locally, and once achieved, synchronize globally, particularly where timing challenges may result in instability in ways that may reduce safety in a vehicle, particularly when operating at high speeds. By dividing up the local and global synchronization as described herein, these methods and apparatuses may permit a system semi-independent/autonomous operation locally while remaining globally synchronized. Further, these methods and apparatuses do not require an external clock.

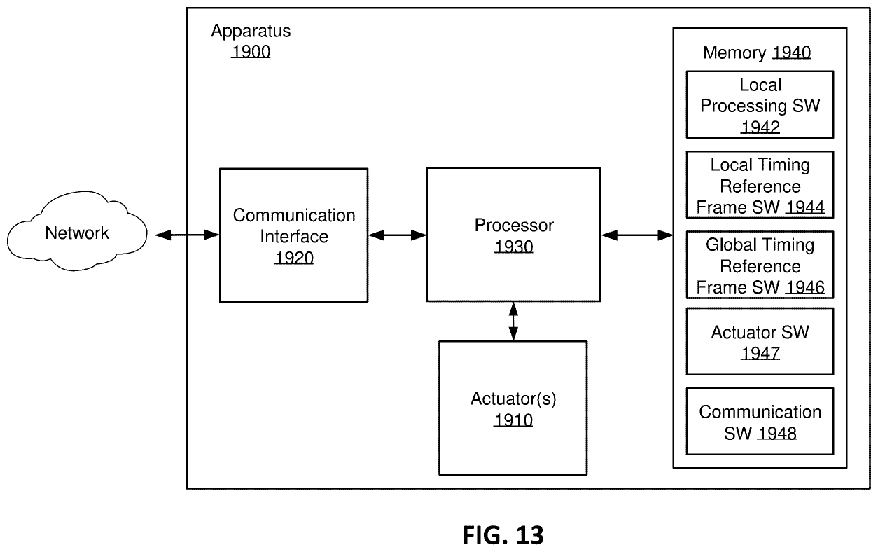

FIG. 13 shows a block diagram of an apparatus 1900 that may be one example of a local system such as local system 710, or any other feasible system, device, or apparatus described herein. The apparatus 1900 may include one or more actuator(s) 1910, a communication interface 1920, a processor 1930, and a memory 1940.

The one or more actuator(s) 1910 can be any feasible linear or rotary actuator described herein. In some examples, the actuators may be attached to and can control automotive steering or suspension components that in turn can control camber, caster, toe-in, toe-out, or any other feasible suspension characteristic. In some implementations, the actuator(s) 1910 can be directly or indirectly coupled to the processor 1930. Thus, the processor 1930 can control the one or more actuator(s) 1910.

The communication interface 1920, which may be coupled to a network and to the processor 1930, may transmit signals to and receive signals from other wired or wireless devices, including any other local or distributed systems. In some examples, the network can be a CAN network. For example, the communication interface 1920 may include wired (e.g., serial, ethernet, CAN, or the like) and/or wireless (Bluetooth, Wi-Fi, cellular, or the like) transceivers that may communicate with any other feasible device through any feasible network.

The processor 1930, which is also coupled to the memory 1940, may be any one or more suitable processors capable of executing scripts or instructions of one or more software programs stored in the apparatus 1900 (such as within memory 1940).

The memory 1940 may include a non-transitory computer-readable storage medium (e.g., one or more nonvolatile memory elements, such as EPROM, EEPROM, Flash memory, a hard drive, etc.) that may store the following software modules: a local processing software (SW) module 1942 to perform one or more operations local to the apparatus 1900; a local timing reference frame SW module 1944 to determine local timing information; a global timing reference frame SW module 1946 to determine global timing information; an actuator SW module 1947 to control the one or more actuator(s) 1910; and a communication SW module 1948 to communicate through the communication interface 1920.

Each software module includes program instructions that, when executed by the processor 1930, may cause the apparatus 1900 to perform the corresponding function(s). Thus, the non-transitory computer-readable storage medium of memory 1940 may include instructions for performing all or a portion of the operations described herein.

The processor 1930 may execute the local processing SW module 1942 to determine actual and target positions of any feasible actuators, including the actuator(s) 1910. In some examples, execution of the local processing SW module 1942 can determine a relative error (difference between actual and target positions) of any feasible actuator.

The processor 1930 may execute the local timing reference frame SW module 1944 to determine local timing reference frame information. Execution of the local timing reference frame SW module 1944 can determine the pacing (e.g. slowest) local actuator. The local timing reference frame can be based on timing of the pacing actuator.

The processor 1930 may execute the global timing reference frame SW module 1946 to determine the timing reference that the apparatus 1900 should use to control and/or move the actuator(s) 1910. In some examples, the global timing reference information can be based on local timing reference information received from other apparatuses.

The processor 1930 can execute the actuator SW module 1947 to actuate or move any feasible actuator, including the actuator(s) 1910. In some examples, the processor 1930 can execute the actuator SW module 1947 based on global timing reference information determined by execution of the global timing reference frame SW module 1947. In this manner, motion or movement of the actuator(s) 1910 can be synchronized with any other apparatus 1900 having access to global timing reference information.

The processor 1930 may execute the communication SW module 1948 to communicate with any other feasible devices. For example, execution of the communication SW module 1948 may enable the apparatus 1900 to communicate via any feasible network to any other feasible device. In some examples, communication by be performed using standards conforming to any of the LTE standards promulgated by the 3^{rd} Generation Partnership Project (3GPP) working group, Wi-Fi networks conforming to any of the IEEE 802.11 standards, Bluetooth protocols put forth by the Bluetooth Special Interest Group (SIG), Ethernet protocols, a serial CAN bus, or the like. In some other embodiments, execution of the communication SW module 1948 may implement encryption and/or decryption procedures.

### Multi-Stage and Notched Breaks

Also described herein are apparatuses (e.g., devices, systems, etc., including hardware, software and/or firmware) for brake mechanisms (“multi-stage and notched breaks”) that may be particularly effective and may optionally be used with any of the control systems described herein. In general, these apparatuses (e.g., mechanisms, including brake mechanisms) may be configured to effectively stop an actuator during movement. This includes operation during high-dynamic driving in a vehicle, which involves high actuation speeds and forces, while maintaining backlash or position accuracy within an acceptable range once the brake is engaged. This mechanism may be particularly important because, in the event of a system failure that could lead to uncontrolled wheel movement (e.g. if vehicle power is lost), brake engagement time is essential to ensure safe vehicle handling and to enable the driver to maintain control. Note that, as used herein, brake refers to stopping any actuator (and not necessarily to a traditional wheel break, such as a disk or drum break for a wheel).

Actuators are increasingly included in vehicles for high-dynamic driving, where they may be subject to high actuation speeds and forces, which may create unique challenges for the brake mechanism stopping the actuator(s). Traditionally, it has not been feasible to effectively stop an actuator and lock it in position when moving at high speed, particularly when using a pin-and-notched-disc mechanism, as is commonly implemented. This limitation comes at least in part from the inverse relationship between the notch size required to achieve low backlash (requiring a small notch) and the size required to achieve reliable engagement at high speeds (requiring a large notch). The apparatuses and methods described herein are specifically configured to provide a brake (e.g., stop) mechanism capable of engaging an actuator at high speeds with low backlash, and which may be positioned on the output stage of an actuator. Placement on the output stage may advantageously minimize the potential for uncontrolled wheel movement due to the failure of components downstream of the brake mechanism.

An electromechanical brake mechanism may be, for example, mounted to the rear shaft of a motor. For example, in the electromechanical break mechanism illustrated in PCTAU2021051194, the mechanism includes a latch and a single-stage brake disc. The brake disc is called a single-stage because there are four identical notches. While this mechanism may work well at lower rotational speeds (e.g. less than about 3,000 rpm), at higher rotational speeds in some conditions the latch may bounce and may not have sufficient time to engage the notches. Described herein are apparatuses and methods that may solve these issues. In some cases, these methods and apparatuses described herein may include notches that are configured to allow more time for engagement and/or may be configured as a multi-stage brake.

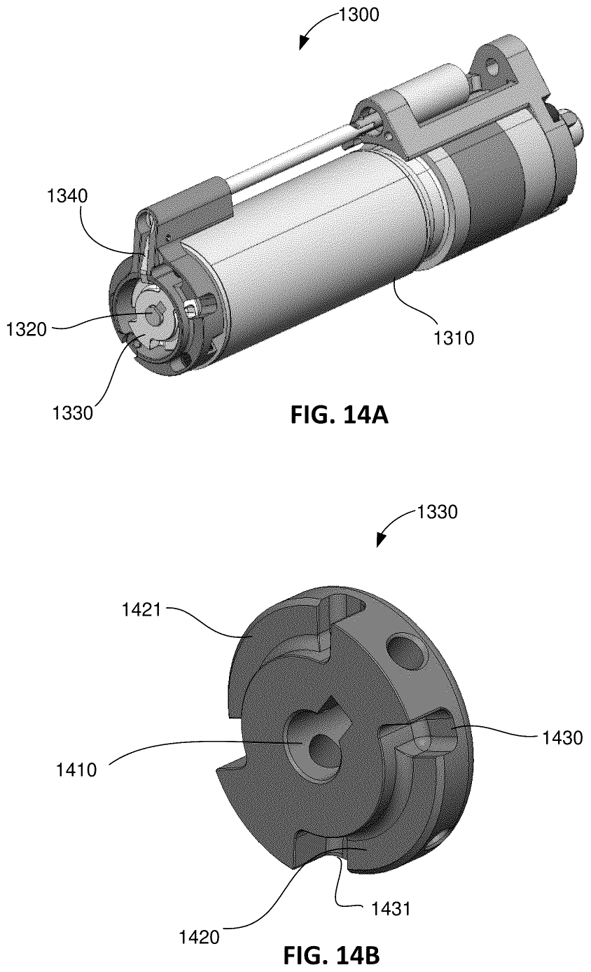

In general, in the break apparatuses described herein, when a high-speed braking event occurs the latch may engage with one of the first stage notches to halt the motor, and then (under spring tension) the latch may fall into one of the second stage notches to hold the motor in position with low backlash. This configuration has been extensively tested in laboratory and in-field conditions (in vehicles) has been found to be effective and highly durable. For example, the mechanisms described herein have been shown to be capable of reliably and effectively stopping a motor at speeds over 6,000 rpm with an average stop time of 21 ms, and with a holding backlash of 0.01 mm or less. Although the examples illustrated in FIGS. 14A to 17A-17B illustrate primarily a two-stage brake mechanism, any number of stages may be used, such as (but not limited to) three-stage or four-stage mechanisms.

Any of these methods and apparatuses may include multiple individually notched surfaces (e.g., discs) that may be installed in series and indexed on a gear, shaft or stage which may be in close proximity to (e.g., in contact with and/or integrated with) the output of the actuator, rather than on the rear shaft of the motor (actuator). Placing the breaking mechanism on the rear shaft of the motor means that a failure in any component situated between the brake and the output shaft/stage of the actuator may result in uncontrolled wheel movement in a vehicle, even if the brake itself operates and engages successfully. This failure mode then means that any component located on this failure path must be classified as safety-critical, triggering a number of costly manufacturing controls on each component to ensure they will not fail. In contrast, the methods and apparatuses described herein may instead locate the breaking mechanism at the front of the actuator (motor), near the output of the actuator. Thus, any of the electromagnetic brake apparatuses (e.g., brake assemblies) described herein may be located on the output stage of the actuator.

Further, these methods and apparatuses may be easily assembled using fewer assembly steps, and without requiring high-dexterity operations. This makes the assembly process significantly time-consuming and labor-intensive, which may decrease both costs and lead time for the actuators as compared to existing systems.

For example, FIG. 14A shows one example 1300 of a rotary actuator system (e.g., motor) including a multi-stage notched break. The rotary actuator system 1300 (sometimes referred to as drive unit) can include a motor 1310, a shaft 1320, a multi-stage notched brake disc 1330, and engagement pin 1340. The motor 1310 rotates the shaft 1320 to provide rotary motion for any feasible system, including any automotive system or sub-system. The multi-stage notched brake disc 1330 (referred to as simply a break disc for convenience) in this example is rigidly coupled to the shaft 1320. In some examples, the shaft 1320 and the multi-stage notched brake disc 1330 can include a keyway with which a corresponding key can be inserted to rigidly couple or “lock” the multi-stage notched brake disc 1330 to the shaft 1320. In some other examples, the shaft 1320 can be “D” shaped or “double-D” shaped and the multi-stage notched brake disc 1330 can include a corresponding D opening or double-D opening to receive the shaft 1320. In some embodiments, the shaft 1320 can include a male spline and the brake disc 1330 can include a corresponding female spline. In FIGS. 13 and 14, the multi-stage notched break disc is configured as a two-sage brake disc, shown in greater detail in FIG. 14B.

The engagement pin 1340 is generally not engaged with or in contact with the multi-stage notched brake disc 1330 while the shaft 1320 and the brake disc 1330 is spinning. However, when the motion of the shaft 1320 is to be locked or braked, the engagement pin 1340 is moved into contact with the brake disc 1330. The engagement pin 1340 can move through and engage with the brake disc 1330 through different engagement regions (also referred to as “stages”) to lock and engage with the brake disc 1330.

The engagement pin 1340 can be a rigid (e.g. hardened), square or rectangular or cylindrically shaped member capable of withstanding the high forces generated during brake engagement. Generally, its thickness or diameter is closely matched to the notches in the brake multi-stage notched disc 1330 to ensure robust engagement and low backlash. In some examples, the engagement pin 1340 is spring-loaded, meaning its resting state is in the engaged (extended) position. This characteristic results in a fail-safe state (e.g. normally-closed brake).

Fail-safe operation may be a key safety feature. Any feasible braking system can be designed to effectively engage if power is lost or cut off. In some examples, a request from the actuator controller due to a fault being detected (e.g., a software error, sensor malfunction, or internal component failure within the actuator system) can trigger the cutting of power to the solenoid, resulting in immediate brake engagement. A loss of power to the system altogether (e.g., due to an electrical fault, battery failure, or emergency shutdown) can also automatically result in the brake engaging. Note that although the examples provided herein for actuators (e.g., motors) and multi-stage notched break assemblies herein are primarily shown as vehicular systems, in which they may find particular use and benefit, these multi-stage notched break assemblies may be used in any appropriate context with an actuator, including non-vehicular apparatuses, such as but not limited to industrial machinery (e.g., pumps, conveyors, turbines, etc.), home appliances (e.g., air conditioners, washing machines, refrigerators, etc.), construction/outdoor tools (e.g., chainsaws, generators, blowers, etc.), and specialized equipment like robotic arms, drones, and medical devices, any of which may use electric, hydraulic, or pneumatic power. This fail-safe design of the multi-stage and notched break assemblies described herein may ensure that under all circumstances an apparatus (e.g., a vehicle), or an actuator of an apparatus, can be brought to a controlled stop, significantly reducing risks associated with system failures and, in the vehicular context, ensuring the driver always maintains control.

In electromagnetic multi-stage and notched break assemblies described herein, the retraction of the engagement pin can be controlled electrically by means of a pull-type solenoid. The solenoid, when energized, can overcome the spring force to retract the engagement pin, thereby allowing the brake disc 1330 to rotate freely. Conversely, when the electrical power to the solenoid is interrupted, the spring immediately forces the pin to extend outwards, seeking engagement with a notch on the brake disc 1330. This simple linear in and out movement of the pin ensures reliable and repeatable engagement and disengagement.

In some examples, the solenoid control strategy can include applying a high voltage (e.g., an overload voltage of 48V) for de-latching the engagement pin, followed by a lower, nominal voltage (e.g., 12V) for holding the pin in its retracted position. It is important to note that these specific voltage values are examples only, and this control strategy can be implemented with any suitable solenoid and corresponding voltage levels.

In some examples, both the engagement pin 1340 and braking disc 1330 may be manufactured from a high tensile steel, such as AISI 4340, as the application demands good hardness and wear resistance. Another example of a suitable material is 316 stainless steel, which is particularly advantageous for applications in harsh or outdoor environments due to its superior corrosion resistance. To further enhance durability, wear resistance, and environmental resilience, the engagement pin 1340 and braking disc 1330 can undergo various surface treatments, including hardening, precision grinding, and protective platings and/or coatings, such as blackening, nickel-plating, or hard chrome-plating. These materials and processes are listed as examples only, other materials required for the specific application are within the scope of this invention.

Another improvement in safety comes from the location of the brake system close to or on the output stage of the actuator. This placement is safer than the previous arrangement on the rear shaft of the motor. As mentioned, in some examples it may be undesirable to place the brake close to the output shaft of the actuator (which interfaces with an upright/wheel assembly). With the multi-stage and notched break on or close to the output shaft, components like the gear train or motor are no longer in the critical path for preventing uncontrolled wheel movement after a brake engagement. This may also reduce or eliminate the requirement for interventions such as “100% inspection” of these components on the production line, yielding cost savings, and improving production efficiency and scalability. However, it is important to note that the present invention can be located anywhere within the drivetrain of the actuator, even far away from the output stage, without departing from the invention.

This multi-stage and notched break assemblies described herein may be simpler and more efficient than prior art breaks including in construction and manufacturing and may be manufactured more quickly (e.g., lower manufacturing time per unit), which also reduces the potential for assembly errors, leading to higher product quality and enhanced reliability in the field. This also makes the design better suited to automated assembly processes, which is crucial for achieving the high-volume series production demanded by vehicle OEMs. Thus, these multi-stage and notched breaks are scalable in a way that prior break assemblies have not been capable of achieving.

Returning to FIGS. 14A-14B, FIG. 14B shows an example the multi-stage and notched break disc 1330 of FIG. 14A. The multi-stage and notched break disc 1330 can include an arbor receiver 1410 (e.g., to receive a rotating shaft or spindle), a primary engagement region 1420 and a secondary engagement region 1430. The arbor receiver allows the multi-stage and notched break disc 1330 to be attached to any feasible rotary shaft, including rotary shafts attached directly or indirectly to a motor, including any electric motor. In some examples, the rotary shaft can be part of a gear box that can be driven by a motor. In some examples, the arbor receiver 1410 may include a keyway to rigidly couple or attach the multi-stage and notched break disc 1330 to a rotating shaft (shaft not shown).

An engagement pin (not shown) can move into the primary engagement region 1420. As shown, the primary engagement region 1420 is much larger than the secondary engagement region 1430. In the example of FIG. 14B, the primary engagement region 1420 can be disposed circumferentially around the multi-stage and notched break disc 1330 and encompass more than ninety degrees of rotation of the brake disc 1330. The engagement pin moves through the primary engagement region 1420 before moving into the secondary engagement region 1430 as an associated braking system is being applied. The relatively large primary engagement region 1420 (relative to the secondary engagement region 1430) enables the engagement pin to easily enter the primary engagement region 1420, even when the brake disc 1330 is rotating at high speed. In some cases, when the primary engagement region 1420 is relatively small (for example, having comparable dimensions as the engagement pin), as the engagement pin advances into the primary engagement region 1420, the engagement pin may “bounce” out of the primary engagement region 1420. This “bounce” may be caused in part by a speed of the engagement pin.

Thus, in any of these multi-stage and notched breaks a secondary engagement region 1430 can be configured (e.g., shaped and positioned) to have approximately the same dimensions as the engagement pin. In some cases, the secondary engagement region 1430 may be a notch that conforms closely to the engagement pin. Thus, as the engagement pin proceeds into the secondary engagement region 1430, the free play or backlash of the multi-stage and notched break disc 1330 with respect to the engagement pin can be minimized. In contrast, the primary engagement region 1420 can have free play or backlash equivalent to or based on the size of the primary engagement region 1420 compared to the engagement pin.

As shown, the secondary engagement region 1430 can be disposed at one end of the first engagement region 1420. In addition the primary engagement region 1420 can include an additional secondary engagement region 1431 at an opposite end of the primary engagement region 1420. Such an arrangement of secondary engagement regions 1430 and 1431 provides two zones that can capture the engagement pin. That is, the multi-stage and notched break disc 1330 can rotate either clockwise or counterclockwise, and the engagement pin can stop rotation of the multi-stage and notched break disc 1330 by engaging with the primary engagement region 1420 and either of the secondary engagement regions 1430 and 1431. Further, in the example of FIG. 14B the multi-stage and notched break disc 1330 can include two or more primary engagement regions. For example, the multi-stage and notched break disc 1330 can also include an additional primary engagement region 1421. The additional primary engagement region 1421 can be similar to the first engagement region 1420. Additional primary engagement regions can advantageously decrease braking time.

FIG. 15 shows another example multi-stage and notched break disc 1500 including a plurality of joined (e.g., rigidly joined) discs: a first stage disc 1525 and a second stage disk 1535, including notches having different profiles, as described above. The multi-stage and notched break 1500 in FIG. 15 can include an arbor receiver 1510, one or more primary engagement region 1520 in the first stage disc, and one or more secondary engagement regions 1530, 1531 (part of a second stage disc 1535). Similar to the arbor receiver 1410 of FIG. 14B, the arbor receiver 1510 can rigidly attach the multi-stage and notched break 1500 to any feasible rotating shaft. In some examples, the arbor receiver 1510 can include an external “D” profile (or double D profile) that can rigidly attach the multi-stage and notched break 1500 to a similarly shaped rotary shaft without requiring a key or keyway.

In one example of the operation of a multi-stage and notched break, the primary engagement region 1520 (part of the first stage disc 1525) can receive an engagement pin (not shown). As the engagement pin moves in the direction of travel 1545 as indicated in FIG. 15, the engagement pin moves through the primary engagement region 1520 into the first or second secondary engagement regions 1530 and 1531. Thus, the engagement pin enters and travels through the primary engagement region 1520 before entering and engaging with the first secondary engagement region 1530 or the second secondary engagement region 1531. In some examples, any of the primary engagement regions, and/or any of the secondary engagement regions can be cut out from a substrate, such as a disk of any feasible material, in addition to or instead of being formed by cutting the edge of a disc.

In some examples, the multi-stage and notched break disc 1500 can include multiple primary engagement regions. In the example of FIG. 15, the brake disc 1500 includes five primary engagement regions 1520 and ten secondary engagement regions 1530, 1531. In some examples, the secondary engagement regions 1530 and 1531 can be notches that closely conform (in size) to the engagement pin. In other examples, the brake disc 1500 can include any number of primary engagement regions and secondary engagement regions. In most cases, each primary engagement region includes two secondary engagement regions. Furthermore, in most cases, the secondary engagement region may be sized to receive the engagement pin, e.g., may have an inner/receiving seating (or channel) diameter approximately 100%-195% (e.g., between>100% and 185%, between>100%-180%, between>100%-175%, between>100%-170%, between >100%-165%, between>100%-160%, between>100%-155%, between>100%-150%, between >100%-145%, between>100%-140%, between>100%-135%, between>100%-130%, between >100%-125%, between>100%-120%, between>100%-110%, between>100%-115%, etc. of the outer diameter of the break pin. The primary engagement region may have a seat (e.g., channel) inner diameter that is configured to have a size equivalent to several (two or more) engagement pins, e.g., >195% the outer diameter of the break pin (e.g., 200% or greater, 225% or greater, 250% or greater, 275% or greater, 300% or greater, 325% or greater, 350% or greater, 375% or greater, 400% or greater, 450% or greater, 500% or greater, etc.) of the outer dimeter of the break pin. In some cases, the primary engagement region 1520 can be radially disposed a first circumferential amount along an edge of the multi-stage and notched break disc 1500 and the secondary engagement region 1530 can be radially disposed a second circumferential amount along the edge of the multi-stage and notched break disc 1500, which is less than the first circumferential amount.

In some examples, as shown in FIG. 15, the multi-stage and notched break disc 1500 may be composed of two disks rigidly attached together. For example the primary engagement region 1520 may be formed from a first disk 1525 and the secondary engagement regions 1530 and 1531 may be formed from a second disk 1535 rigidly attached to the first disk 1525.

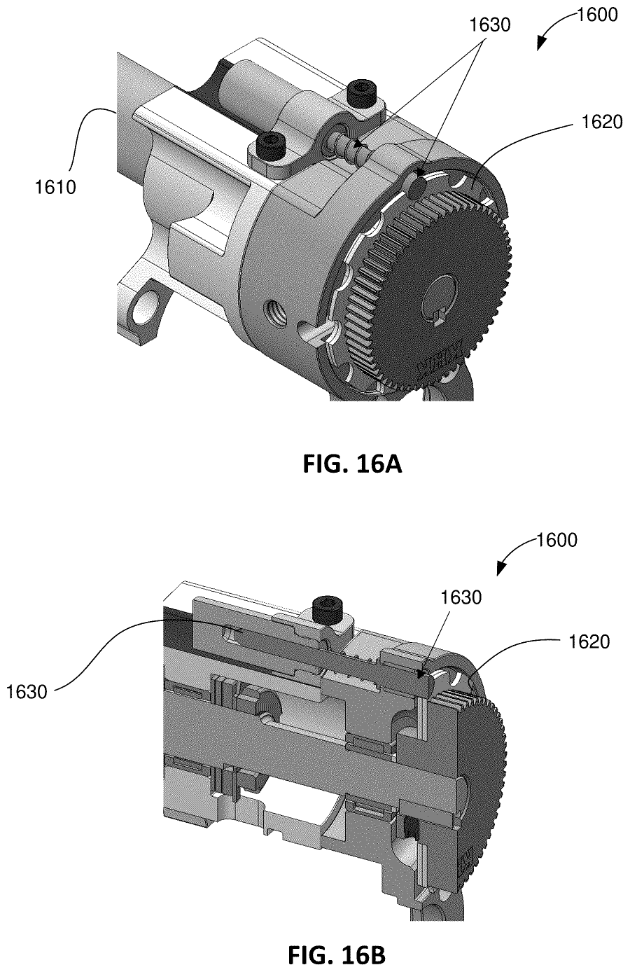

FIGS. 16A and 16B show an example braking system 1600. The system 1600 can include a shaft 1610, a multi-stage (in this example, a two-stage) and notched break disc 1620 and an engagement pin 1630. The two-stage and notched break disc 1620 can be, for example, similar to the two-stage and notched break disc 1500 of FIG. 15. As shown in FIGS. 16A-16B, the two-stage and notched break disc 1620 is rigidly attached to the shaft 1610 at the output (distal) end of the direct drive configuration. The engagement pin 1630 is shown extended into the two-stage and notched break disc 1620 and further into a secondary engagement region of the two-stage and notched break. The secondary engagement region can be shaped to closely fit the engagement pin 1630 as described above, to minimize motion and/or backlash of the brake disc 1620. FIG. 16B shows a cross-section of the two-stage and notched break assembly 1620 of FIG. 16A. The engagement pin 1630 is extended through primary and secondary engagement regions of the two-stage and notched break disc 1620.

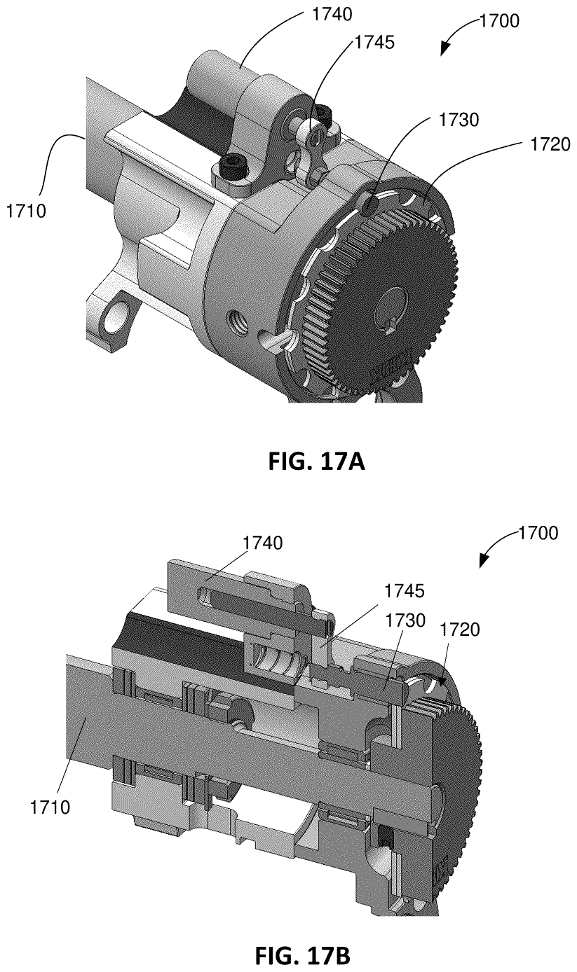

FIGS. 17A and 17B show another example of a system 1700 including an actuator (e.g., motor) having a drive shaft 1710 with a two-stage and notched break disk mounted thereto, similar to that shown in FIGS. 16A-16B. The system 1700 includes a shaft 1710, a two-stage and notched break disc 1720, an engagement pin 1730, and an electromagnetic actuator 1740 (e.g., solenoid) driving the pin 1730. The two-stage and notched break disc 1720 is shown rigidly coupled to the shaft 1710. The engagement pin 1730 is shown extended into the notches of the two-stage and notched break disc 1720. In some examples the electromagnetic actuator 1740 is indirectly coupled to the engagement pin 1730 as shown in FIGS. 17A-17B; the electromagnetic actuator 1740 is coupled through a linkage (e.g., an arm 1745) to the engagement pin 1730. FIG. 17B shows a cross-section of the system 1700, including the electromagnetic actuator 1740, pin 1730, linkage 1745 and two-stage and notched break disk 1720.

In operation, the multi-stage and notched breaks described herein are surprisingly effective and robust, particularly as compared to existing breaks (including rear motor shaft breaks). The stage and notched breaks described herein are more durable by a factor of at least 4× as compared to existing rear-break systems, which typically fail to engage effectively after around 50 stops; the stage and notched breaks continue to shows effective engagement after 200 stops. In direct comparison, the stage and notched breaks described herein had an average travel from maximum speed to a full stop that was 0.8 mm or less as compared to existing breaks (at 1.4 mm), while time to stop decreased from 21 ms to 16 ms with the multi-stage and notched break.

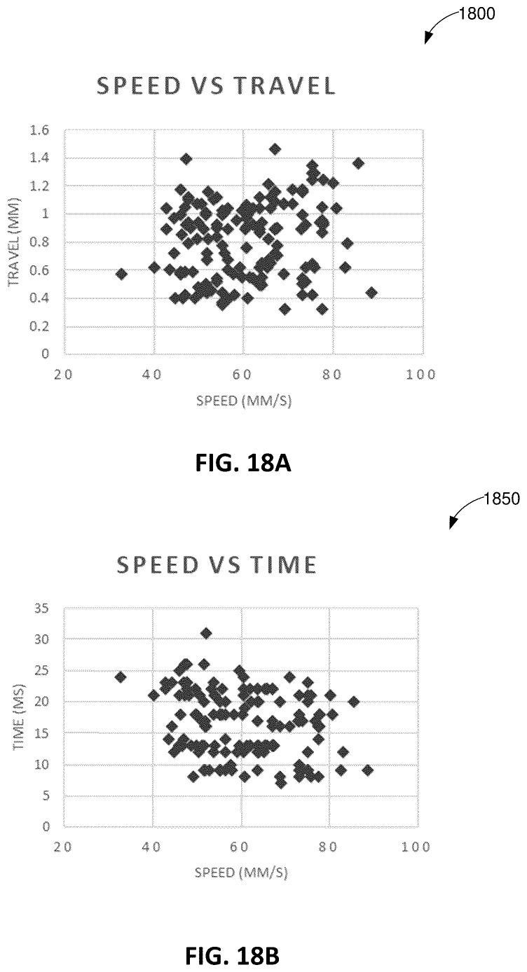

FIG. 18A is a graph 1800 that shows speed vs travel for an example braking system, such as the braking system 1600 of FIG. 16A or the braking system 1700 of FIG. 17A. In some examples, average travel from a maximum speed to full stop decreased from 1.4 mm to 0.8 mm. FIG. 18B is a graph 1850 that shows speed vs time for an example braking system. In some examples, a time to stop has decreased from 21 ms to 16 ms.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of synchronizing a plurality of electronic control units (ECUs), the method comprising, for each ECU of the plurality of ECUs:
determining a local timing reference frame, wherein each local timing reference frame contains timing information for one or more actuators controlled by a respective ECU of the plurality of ECUs;
transmitting the local timing reference frame to all other ECUs of the plurality of ECUs over a shared communication bus;
determining a global timing reference frame, based on the local timing reference frame of all ECUs of the plurality of ECUs;
determining a target position for the one or more actuators controlled by the respective ECU of the plurality of ECUs based on the global timing reference frame; and
initiating movement of the one or more actuators controlled by the respective ECU of the plurality of ECUs based on the determined target position.

2. The method of claim 1, further comprising initiating movement of the one or more actuators based on the determined target position.

3. The method of claim 1, wherein one or more of the one or more actuators controls steering of a motor vehicle.

4. The method of claim 1, wherein one or more of the one or more actuators controls a suspension of a motor vehicle.

5. The method of claim 1, wherein the timing information is based on a slowest actuator controlled by an ECU of the plurality of ECUs.

6. The method of claim 1, wherein determining the global timing reference frame, based on the local timing reference frame of all ECUs of the plurality of ECUs further comprises waiting to receive a first message in ECU of the plurality of ECUs prior to determining a second local timing reference frame.

7. The method of claim 1, wherein the global timing reference frame is based on a slowest actuator controlled by an ECU of the plurality of ECUs.

8. A method of synchronizing a plurality of electronic control units (ECUs), the method comprising:
receiving, by a first ECU of the plurality of ECUs, a first message from a second ECU, wherein the first message includes a first local timing reference frame for actuators controlled by a second ECU of the plurality of ECUs;
determining a second local timing reference frame for actuators controlled by the first ECU, wherein the second local reference frame includes timing information for the actuators controlled by the first ECU; and
determining, based on the first local timing reference frame and the second local timing reference frame, a global timing reference frame, wherein the global timing reference frame includes timing information to synchronize the actuators controlled by the first ECU and the actuators controlled by the second ECU.

9. The method of claim 8, further comprising determining a target position for the actuators controlled by the first ECU and the actuators controlled by the second ECU based on the global timing reference frame.

10. The method of claim 9, further comprising initiating actuator movement based on the determined target position.

11. The method of claim 9, wherein one or more of the actuators control a steering geometry of a motor vehicle.

12. The method of claim 9, wherein one or more of the actuators control a suspension geometry of a motor vehicle.

13. The method of claim 8, wherein the timing information to synchronize the actuators controlled by the first ECU and the actuators controlled by the second ECU is based on a slowest actuator controlled by the first ECU and the second ECU.

14. The method of claim 8, further comprising transmitting, by the first ECU, a second message to the second ECU determining the global timing reference frame.

15. The method of claim 8, further comprising waiting, by the first ECU, to receive the first message prior to determining the second local timing reference frame.

16. The method of claim 8, wherein the global timing reference frame is based on a slowest actuator controlled by the first ECU and the second ECU.

17. A method of synchronizing a plurality of electronic control units (ECUs), the method comprising:
waiting, by a first ECU, a predetermined time period;
determining, after the predetermined time period, a local timing reference frame, wherein the local timing reference frame includes timing information for one or more actuators controlled by the first ECU;
transmitting a first message to a second ECU, wherein the first message includes the local timing reference frame;
receiving a second message from the second ECU, wherein the second message includes a global timing reference frame with timing information to synchronize the one or more actuators controlled by the first ECU and actuators controlled by the second ECU; and
determining a target position for the actuators controlled by the first ECU based on the global timing reference frame.

18. The method of claim 17, further comprising waiting to receive the second message after transmitting the first message, wherein the target position is not determined until after the second message is received.

19. The method of claim 18, further comprising initiating actuator movement based on the determined target position.

20. The method of claim 17, further comprising waiting an additional predetermined time period after determining the target position before updating the local timing reference frame.
